(19) United States
(12) Patent Application Publication
(10) Pub. No.: US 2026/0018668 A1
(43) Pub. Date: Jan. 15, 2026

(54) ADDITIVE COMBINATION FOR SECONDARY BATTERY ELECTROLYTES

(71) Applicant: INSTITUT NATIONAL DE LA RECHERCHE SCIENTIFIQUE, Quebec (CA)

(72) Inventors: Hongliu DAI, Longueuil (CA); Gaixia ZHANG, Sainte-Julie (CA); Sun SHUHUI, Sainte-Julie (CA)

(21) Appl. No.: 18/841,713

(22) PCT Filed: Mar. 2, 2023
(86) PCT No.: PCT/CA2023/050270

§ 371 Date: Aug. 27, 2024

Related U.S. Application Data
(60) Provisional application No. 63/268,898, filed on Mar. 4, 2022.

(51) Int. Cl. H01M 10/0567; H01M 10/0525

(52) U.S. Cl. CPC H01M 10/0567; H01M 10/0525; H01M 2300/0025

(57) ABSTRACT

An additive combination for an electrolyte for a secondary battery is provided. The additive combination comprises a thiol compound and an aromatic Schiff base. An electrolyte for a secondary battery comprising a salt and this additive combination is also provided together with a method of manufacturing this electrolyte. A secondary battery comprising an anode, a cathode, and this electrolyte between the anode and the cathode is provided together with a method of manufacturing this battery. In this battery, at least one electrode surface bears a layer comprising the thiol compound and the aromatic Schiff base. Finally, an electrode having a surface layer comprising the thiol compound and the aromatic Schiff base is also provided together with a method for manufacturing such electrode.

### CROSS REFERENCE TO RELATED APPLICATIONS

This application claims benefit, under 35 U.S.C. § 119(e), of U.S. provisional application Ser. No. 63/268,898, filed on Mar. 4, 2022. All documents above are incorporated herein in their entirety by reference.

### FIELD OF THE INVENTION

The present invention relates to a combination of additives for secondary battery electrolytes. More specifically, the present invention is concerned with the use of a combination of a thiol compound and an aromatic Schiff base as additives for use in electrolytes of secondary batteries.

### BACKGROUND OF THE INVENTION

Metallic lithium is a promising anode electrode for next-generation high-energy lithium batteries. However, the uncontrollable growth of lithium dendrites and the instability of solid electrolyte interphase (SEI) films have severely restricted the large-scale commercial application of lithium metal-based batteries.

Recently, lithium metal batteries (LMBs) have been regarded as one of the most promising next-generation energy storage devices for various applications, due to the ultrahigh theoretical capacity (3860 mAh g⁻¹) and the lowest negative potential (−3.04 V vs standard hydrogen electrode) of lithium (Li) anodes.¹⁻⁴

LMBs, including Li|LifePO₄ (LFP) batteries, Li-sulfur (Li—S) batteries, Li|LiNiₓCo_{y}Mn_{1-x-y}O₂ (NCM) batteries, Li-oxygen (Li—O₂) batteries, have drawn great attention from the renewable energy storage field⁵⁻⁸, however, some serious problems of Li anode and cathode materials still exist. On the Li anode side, electrolyte decomposition and Li surface corrosion occur due to the high reactivity of Li. In addition, the rough and uneven Li surface may facilitate Li dendrite generation, which leads to internal short circuits, low active Li utilization, low coulombic efficiency, significant volume change and thermal runaway^{3,9,10}. Meanwhile, many factors can cause the degradation of cathode materials: (i) the severe shuttle effect of polysulfide leads to rapid capacity decay of lithium-sulfur battery¹¹; (ii) the vacancy defects of Li and the occupation of Li sites by Fe choke of the diffusion path of Li⁺ ions, resulting in the poor performance of LFP cathode¹²; (iii) Li—Ni cation disorder, oxygen release, dissolution of transition metals, electrolyte decomposition cause the degradation of NCM performance¹³. All these issues significantly hinder the practical applications of LMBs in electric vehicles and large-scale energy storage systems.

To overcome these challenges, interfacial layer engineering is a promising strategy to construct a dense and stable solid electrolyte interface (SEI) film to inhibit Li dendrite growth at the anode and provide a fast Li⁺ ion pathway at the cathode surface via cathode electrolyte interface (CEI) film. In the literature, interfacial layers have been made to protect anode or cathode electrodes by various techniques, such as atomic layer deposition (ALD), spin coating, self-assembly, pulsed laser deposition, and chemical vapor deposition (CVD)¹⁴⁻¹⁷, etc. For example, Zhang et al. reported excellent cyclic performance of 1200 hours at 0.5 mA cm⁻²/1 mAh cm⁻² by self-assembly (Pyr₁₃FSI ionic liquid) of pre-treating the Li surface⁵. Chen et al. reported a protective conductive polymer skin on NCM cathode materials via oxidative CVD method and the battery delivered high capacity retention (91%)¹⁶. However, these measures cannot achieve simultaneous in-situ modification of both the anode and the cathode electrodes during battery operation. For this purpose, Guo et al.⁸ added 1,3-dioxolane to an ester-based electrolyte to form a stable electrode/electrolyte interface at the anode and the cathode. Although this strategy can deliver excellent electrochemical performance in Li|NCM pouch battery, the cyclic stability of the Li anode is still poor (less than 225 cycles at 0.5 mA cm⁻²/1.0 mAh cm⁻²). Recently, Liu et al.⁶ introduced highly fluorinated ether solvent (LiPO₂F₂) in a blank electrolyte and obtained an energy density beyond 400 Wh kg⁻¹ for a Li|NCM pouch cell. However, due to the low solubility of LiPO₂F₂ in the electrolyte, this strategy cannot be applied on a large scale.

Therefore, it is necessary to explore an efficient in-situ interfacial modification strategy to further enhance the performance of LMBs. The key requirements are as follows: (i) modifying the rough and uneven Li anode surface to inhibit the formation of Li dendrites and reduce the corrosion of Li metal from an electrolyte; and (ii) constructing the CEI film that has excellent Li⁺ insertion kinetics and high stability to improve the electrochemical performance of cathode materials. Further, an in-depth understanding of the protection mechanism of Li anode and cathode materials (e.g., LFP, NCM) is still lacking.

On another subject, self-assembly has demonstrated broad application prospects in the fields of electrode preparation, surface modification and anti-corrosion due to its simple preparation, good structural order, good film-forming effect, good stability, and controllable film thickness and performance^{5,18,19}. Additionally, a mixed self-assembled molecular layer (MSAM) with two or more molecules has attracted great attention due to its high compactness and stability^{20,21}.

### SUMMARY OF THE INVENTION

In accordance with the present invention, there is provided:

1. An additive combination for an electrolyte for a secondary battery, the additive combination comprising a thiol compound and an aromatic Schiff base.
2. Use of a thiol compound together with an aromatic Schiff base as additives for an electrolyte for a secondary battery.
3. An electrode having a surface and comprising a layer on said surface, wherein said layer comprises a thiol compound and a aromatic Schiff base.
4. A method of manufacturing an electrode, the method comprising the steps of allowing a thiol compound and an aromatic Schiff base to self-assembled on a surface of said electrode to form a layer.
5. The combination/use/electrode/method of any one of embodiments 1 to 4, wherein the thiol compound and the aromatic Schiff base in a thiol compound/aromatic Schiff base gravimetric ratio between about 6 and about 2000, preferably between about 50 and about 100.
6. The combination/use/electrode/method of any one of embodiments 1 to 5, wherein the thiol compound is of formula (1):

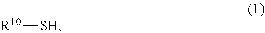

wherein R¹⁰ is a linear or branched alkyl, unsubstituted or substituted by one or more of —COOH, —SH, —C(═O)—R²⁰, —NH₂, or —O—C(═O)—R²⁰, and
wherein R²⁰ is a linear or branched alkyl, a cycloalkyl, or a heterocycloalkyl, each of which being unsubstituted or substituted by one or more of —COOH, —SH, or —C—O—R²¹, wherein R²¹ is a linear or branched alkyl.
   7. The combination/use/electrode/method of embodiment 6, wherein R¹⁰ is a linear or branched C₁-C₁₈ alkyl, and most preferably a linear or branched C₁₀-C₁₄ alkyl, and most preferably a linear or branched C₁₂ alkyl (i.e., dodecanyl).
   8. The combination/use/electrode/method of 6 or 7, wherein R¹⁰ is unsubstituted or substituted by —SH, preferalby unsubstituted.
   9. The combination/use/electrode/method of any one of embodiments 6 to 8, wherein the alkyl in R²⁰ is C₁-C₁₂ alkyl.
   10. The combination/use/electrode/method of any one of embodiments 6 to 9, wherein the cycloalkyl in R²⁰ is a one- or two-ring cycloalkyl, preferably wherein the ring(s) of the cycloalkyl in R²⁰ comprises 5 or 6 carbon atoms.
   11. The combination/use/electrode/method of any one of embodiments 6 to 10, wherein the heterocycloalkyl in R²⁰ is a one- or two-ring heterocycloalkyl, preferably a one-ring heterocycloalkyl,
wherein the ring(s) of the heterocycloalkyl in R²⁰ preferably comprises 5 or 6 ring atoms, more preferably 5 ring atoms,
wherein the ring(s) of the heterocycloalkyl in R²⁰ preferably comprises exactly one heteroatom,
wherein the heteroatom(s) in the heterocycloalkyl in R²⁰ is(are) preferably nitrogen.
   12. The combination/use/electrode/method of any one of embodiments 6 to 11, wherein the heterocycloalkyl in R²⁰ is pyrrolidinyl, preferably N-pyrrolidinyl.
   13. The combination/use/electrode/method of any one of embodiments 6 to 12, wherein the heterocycloalkyl in R²⁰ is substituted, preferably with —COOH.
   14. The combination/use/electrode/method of embodiment 6, wherein the thiol compound is methanethiol, ethanethiol, ethanedithiol, 1-propanethiol, 1,3-propanedithiol, captopril, tert-dodecyl mercaptan, 1-dodecanethiol, hexadecanethiol, 16-Mercaptohexadecanoic acid, or occtadecanethiol, preferably 1-dodecanethiol.
   15. The combination/use/electrode/method of any one of embodiments 1 to 14, wherein the aromatic Schiff base is a secondary aldimine.
   16. The combination/use/electrode/method of any one of embodiments 1 to 15, wherein the aromatic Schiff base is of formula (2):

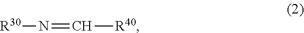

wherein R³⁰ and R⁴⁰ are independently aryl or heteroaryl, each independently unsubstituted or substituted with one or more of —OH, alkyl, a halogen atom, or a sulfur atom.
   17. The combination/use/electrode/method of embodiment 16, wherein the aryl and/or heteroaryl in R³⁰ and R⁴⁰ are independently unsubstituted or substituted with one or more, preferably with up to two, and more preferably up to only one, of the following substituents: OH, alkyl, a halogen atom, or a sulfur atom,
wherein the alkyl is preferably C₁-C₁₂ alkyl, more preferably C₁-C₈ alkyl.
wherein the halogen atom is preferably a fluoride atom.
   18. The combination/use/electrode/method of embodiment 17, wherein the substituent(s) on the aryl and/or heteroaryl are located at position 2 or 3, position 1 being the ring atom to which the secondary aldimine group (—N═CH—) is attached,
wherein the substituent(s) on the aryl in R³⁰ and/or R⁴⁰ is located at position 2.
   19. The combination/use/electrode/method of any one of embodiments 16 to 18, wherein the aryl or heteroaryl in R³⁰ is unsubstituted or substituted with one or more of —OH, alkyl, a halogen atom, or a sulfur atom, preferalby unsubstituted or substituted with only one of —OH, alkyl, a halogen atom, or a sulfur, and most preferably unsubstituted.
   20. The combination/use/electrode/method of any one of embodiments 16 to 19, wherein the aryl or heteroaryl in R⁴⁰ is unsubstituted or substituted with one or more —OH, preferably substituted with only one-OH.
   21. The combination/use/electrode/method of any one of embodiments 16 to 20, wherein the aryl in R³⁰ and/or R⁴⁰ is a one- or two-ring aryl, preferably a one-ring aryl.
   22. The combination/use/electrode/method of any one of embodiments 16 to 21, wherein the aryl in R³⁰ and/or R⁴⁰ is phenyl.
   23. The combination/use/electrode/method of any one of embodiments 16 to 22, wherein R⁴⁰ is 2-hydroxyphenyl (1 being the point of attachment of the aryl to the secondary aldimine group).

24. The combination/use/electrode/method of any one of embodiments 16 to 23, wherein the heteroaryl in R³⁰ and/or R⁴⁰ is a one- or two-ring heteroaryl, preferably a one-ring heteroaryl,
wherein the ring(s) of the heteroaryl in R³⁰ and/or R⁴⁰ preferably comprises 5 or 6 ring atoms, more preferably 6 ring atoms,
wherein the ring(s) of the heteroaryl in R³⁰ and/or R⁴⁰ preferably comprises at least one heteroatom, preferably only one heteroatom, and
wherein the heteroatom(s) in the heteroaryl in R³⁰ and/or R⁴⁰ preferably is(are) nitrogen.

25. The combination/use/electrode/method of any one of embodiments 16 to 24, wherein the heteroaryl in R³⁰ and/or R⁴⁰ is pyridinyl, preferably 2-pyridinyl.

26. The combination/use/electrode/method of any one of embodiments 16 to 25, wherein R³⁰ is pyridinyl, preferably 2-pyridinyl.

27. The combination/use/electrode/method of any one of embodiments 16 to 26, wherein the aromatic Schiff base is one of the following:
2-((Pyridin-2-ylimino)methyl)phenol,
2-((3-methylpyridin-2-ylimino)methyl)phenol,
2-((4-methylpyridin-2-ylimino)methyl)phenol,
2-((4-alkylpyridin-2-ylimino)methyl)phenol,
2-((3-alkylpyridin-2-ylimino)methyl)phenol,
2-((4-fluoropyridin-2-ylimino)methyl)phenol,
2-((4-thiopyridin-2-ylimino)methyl)phenol,
2-((3-fluoropyridin-2-ylimino)methyl)phenol, or
2-((3-thiopyridin-2-ylimino)methyl)phenol,
and preferably is 2-(pyridin-2-yliminomethyl)-phenol.
   28. An electrolyte for a secondary battery, the electrolyte comprising a conducting salt and the additive combination of any one of embodiments 1 to 27.
   29. A method of manufacturing an electrolyte for a secondary battery, the method comprising the step of combining together a conducting salt and the additive combination of any one of embodiments 1 to 27.
   30. The electrolyte/method of embodiment 28 or 29, wherein the electrolyte comprises between about 0.1 and about 15 v/v %, preferably between about 1 and about 5 v/v %, of the thiol compound based on the total volume of the electrolyte.
   31. The electrolyte/method of any one of embodiments 28 to 30, wherein the electrolyte comprises between about 0.1 mol L⁻¹ and about 10.0 mol L⁻¹, preferably between about 0.5 and about 2.5 mol L⁻¹ of the of Schiff base.
   32. The electrolyte/method of any one of embodiments 28 to 31, wherein the electrolyte comprises the thiol compound and the aromatic Schiff base in a thiol compound/aromatic Schiff base gravimetric ratio between about 6 and about 2000, preferably between about 50 and about 100.
   33. A secondary battery comprising an anode, a cathode, and the electrolyte of any one of embodiments 28 to 32 between the anode and the cathode, wherein at least one electrode surface bears a layer comprising the thiol compound and the aromatic Schiff base.
   34. Use of the electrolyte of any one of embodiments 28 to 32 in a secondary battery, wherein at least one electrode surface bears a layer comprising the thiol compound and the aromatic Schiff base.

35. A method of manufacturing a secondary battery in which at least one electrode surface bears a layer comprising a thiol compound and a aromatic Schiff base, the method comprising the steps of assembling together an anode, a cathode, and the electrolyte of any one of embodiments 28 to 32 between the anode and the cathode.

36. The battery/use/method of any one of embodiments 33 to 35, wherein the layer is about 5 to about 150 nm thick, preferably about 60 to about 85 nm thick, and most preferably about 76.5 nm thick.

### BRIEF DESCRIPTION OF THE DRAWINGS

In the appended drawings:

FIG. 1 shows (a) The preparation progress of HL and (b) the molecular structure of DT and HL.

FIG. 2 (a-c) shows SEM images of Li soaked: in blank electrolyte (a), electrolyte with DT (b), and DT-HL additives (c).

FIG. 3 (a-c) shows digital images of Li surface: Li surface morphology in blank electrolyte (a), 2% DT additive (b), 2% DT-1.0 mM HL additives (c) at a current density of 1 mA cm⁻² after 1^{st} cycle.

FIG. 4 is a schematic illustration of Li deposition in different electrolyte systems (a).

FIG. 5 (a-b) shows the adsorption energy of 1-dodecanethiol (DT) (a) and 2-(pyridin-2-yliminomethyl)-phenol (HL) (b) molecules on Li.

FIG. 6 shows the calculated adsorption energy.

FIG. 7 (a-c) shows Li 1s spectra of the Li anode immersed in various electrolyte additives (blank (a), 2% DT (b), and 2% DT-1.0 mM HL (c)).

FIG. 8 shows the Li 1s spectra of Li anode immersed in different electrolyte systems.

FIG. 9 (a-c) shows top-view Scanning Electron Microscope (SEM) images of Li deposition on Cu foil with blank electrolyte (a), with 2% DT additive (b) and 2% DT-1.0 mM HL (c).

FIG. 10 (a-h) shows the SEM characterizations of Li anode. Top-view SEM images of pristine Li foil (a, b), and lithium deposition on Cu foil after 3 cycles with blank electrolyte (c, d), electrolyte with 2% DT additive (e, f) and electrolyte 2% DT-1.0 mM HL additives (g, h).

FIG. 11 (a-b) shows Li deposition process characterized by in-situ optical microscope with blank electrolyte (a), electrolyte with 2% DT additive (b), and electrolyte with 2% DT-1.0 mM HL additive (c).

FIG. 12 (a-c) shows the electrochemical performance of Li symmetric cells in different electrolyte systems. The long cycling performance of symmetric cell at 2 mA cm⁻²/1 mAh cm⁻² (a), 1 mA cm⁻²/0.5 mAh cm⁻² (b), 6 mA cm⁻²/1 mAh cm⁻² (c).

FIG. 13 shows the rate performance of different electrolytes measured at current densities of 1, 2 and 4 mA cm⁻² for 0.5 h each of Li plating and stripping.

FIG. 14 (a-d) shows the electrochemical performance of Li|Li symmetric cells with different DT concentrations[(a) 1 and 2% DT; (b) 2 and 5% DT, (c) 2 and 8% DT, and (d) 2 and 10% DT] at 2 mA cm⁻²/1 mAh cm⁻².

FIG. 15 (a-e) shows the electrochemical performance of Li|Li symmetric cells with different HL concentrations [(a) blank and 0.5 nM HL, (b) bland and 1 nM HL, (c) blank and 2 nM HL, (d) blank and 5 nM HL, and (e) blank and 10 nM HL] at 2 mA cm⁻²/1 mAh cm⁻².

FIG. 16 shows the electrochemical performance of Li|Li symmetric cells with different additives at 6 mA cm⁻²/1 mAh cm⁻².

FIG. 17 (a-c) shows the coulombic efficiency with various additives. The voltage profiles of the 1st (a), 15th (b) and 80th (c) cycles in different additives systems.

FIG. 18 shows the electrochemical interface impedance spectroscopy of treated and untreated electrolytes was conducted at 6 mA cm⁻²/1 mAh cm⁻².

FIG. 19 shows the equivalent circuits of the electrochemical impedance spectroscopy and fitting results.

FIG. 20 (a, b) shows the electrochemical impedance spectroscopy (EIS) spectra for blank and modified electrolytes [(a) 2% DT+1 nM HL and (b) blank and 2% DT] before cycling at a current density of 6 mA cm⁻² and a fixed capacity of 1 mAh cm⁻².

FIG. 21 (a-i) shows the SEM images at different magnifications of Li anode with untreated electrolyte (a-c), 2% DT additive (d-f), and 2% DT-1.0 mM HL additives (g-i) after 100 cycles.

FIG. 22 (a-b) shows the differential capacitance curves conducted at 298 K without electrolyte additives (a) and with the different concentrations of DT additive (b).

FIG. 23 (a-b) shows the S 2p (a) and N 1s (b) XPS spectra of the surface of the Li anode treated with an electrolyte containing 2% DT-1.0 mM HL additives.

FIG. 24 (a-b) shows the DT (a) and HL (b) molecules absorbed on Li.

FIG. 25 is a schematic illustration of DT-HL additives on Li surface.

FIG. 26 The dielectric constant of ester electrolyte containing different additives.

FIG. 27 shows the charge density difference of different additives: DT (a), DT+HL (b).

FIG. 28 shows the electrons transferred with different additives.

FIG. 29 (a-d) shows the AFM images and data in different electrolyte systems. AFM images of blank electrolyte (a), electrolyte with 2% DT additive (b), and electrolyte with 2% DT-1.0 mM HL (c). The enlarged figure of (c) is displayed in (d).

FIG. 30 (a-b) shows the thickness evaluation of electrolyte with or without additives from (29a-c): thickness (a), and thickness (left columns) and roughness (right columns) (b).

FIG. 31 (a-c) shows the fluorescence yield (FLY) of Li K-edge (a), P L-edge (b), and S L-edge (c) XANES spectra of Li surface in different electrolyte systems.

FIG. 32 shows the linear sweep voltammetry (LSV) curves of Li|Cu cells assembled with or without DT/DT-HL additives at a scan rate of 10 mV s⁻¹. The inset figure is the enlarged figure of DT-HL.

FIG. 33 shows the Zeta potential of different ester electrolytes at room temperature.

FIG. 34 (a-f) shows the X-ray photoelectron spectroscopy (XPS) analysis of Li anode in different electrolyte systems. C 1s [(a) blank, (b) 2% DT, and (c) 2% DT+HL] and Li 1s [(c) blank, (d) 2% DT, and e) 2% DT+HL] spectra of the SEI film on the surface of the Li anode after three cycles.

FIG. 35 shows the Tafel experiment of different electrolyte additives after 10 cycles.

FIG. 36 shows the exchange current density values calculated from Tafel curves based on ester electrolyte with or without electrolyte additives.

FIG. 37 shows the electrochemical performance of Li|LiFePO₄ full cell. Rate performance at different current densities.

FIG. 38 shows the discharge-charge curves at different current densities in DT-HL dual-additives.

FIG. 39 (a, b) Discharge-charge curves of the Li|LiFePO₄ cells with blank electrolyte (a) and electrolyte with the DT additive (b) corresponding to FIG. 37.

FIG. 40 shows the Nyquist plots before cycling and after 1 cycle using electrolyte with or without additives.

FIG. 41 shows the electrochemical impedance spectroscopy (EIS) results for the blank electrolyte and the electrolytes with the additives before cycling in Li|LiFePO₄ full cell.

FIG. 42 (a-f) shows the C 1s [(a) blank, (b) 2% DT, and (c) 2% DT+HL] and F 1s [(c) blank, (d) 2% DT, and e) 2% DT+HL] XPS spectra of LifePO₄ cathodes in Li|LiFePO₄ full cells with different ester electrolytes at a low current density.

FIG. 43 shows the fitting results of EIS measurements. Inset Figure is the equivalent circuit of the electrode impedance spectra.

FIG. 44 shows the long cyclic performance at 2 C in different electrolyte systems.

FIG. 45 shows the discharge-charge curves in various electrolyte systems.

FIG. 46 shows the mass transport effect in Li|LiFePO₄ cell with blank or modified electrolytes.

FIG. 47 shows the cycle performance of full cell at the condition of lean electrolyte.

FIG. 48 shows the cycling performance of Li|LiNi_{0.8}Co_{0.1}Mn_{0.1}O₂ full cells with or without electrolyte additives at a current density of 1 C.

FIG. 49 (a-f) are top-view SEM images of the Li anode in Li|LiNi_{0.8}Co_{0.1}Mn_{0.1}O₂ full cells containing single DT additive electrolyte at three different magnifications (a-c), and electrolytes modified with DT-HL additives at three different magnifications (d-f) after 300 cycles (Scale bars: a, d 100 μm; b, e 50 μm; c, f 20 μm).

### DETAILED DESCRIPTION OF THE INVENTION

Turning now to the invention in more details, there is provided an additive combination for an electrolyte for a secondary battery, the additive combination comprising a thiol compound and an aromatic Schiff base. Further, there is provided the use of the thiol compound together with the aromatic Schiff base as additives for an electrolyte for a secondary battery.

As shown in Example 1 below, the thiol compound together with the aromatic Schiff base self-assemble into a protective layer on the anode and/or the cathode of secondary batteries. Typically, a protective layer is formed on both the anode and cathode. The invention, therefore, provides a method for the simultaneous protection of both electrodes. In contrast, methods of protection in the prior art typically can only protect the anode or the anode. This protection can, for example, suppress dendrite growth and improve the Li+ ions transfer in Li metal batteries.

Furthermore, in the present invention, the electrolyte is protected from decomposition as well. Indeed, as shown in Example 1, less decomposition products were observed when using the additive combination of the invention.

In fact, the additive combination of the invention provides a protection at the electrolyte/electrode interfaces. This makes the invention useful for a wide variety of secondary batteries, electrodes, and electrolytes. The additive combination is compatible with a variety of commercial electrolytes and electrodes and can therefore be used directly in conventional commercial batteries. More specifically, in Example 1, it is noted that the additive combination of the invention protects Li metal anodes as well as high energy density cathode materials. This should ease the development of practical high-energy-density lithium metal secondary batteries.

The invention provides a simple, easy, quick, and cheap way of protecting the anode, the cathode, and/or the electrolyte of a secondary battery. Of particular interest, this protection can be effected in-situ since the thiol compound and the aromatic Schiff base can be conveniently provided as part of the electrolyte of the secondary battery. The use of the additive combination of the invention is therefore advantageously compatible with existing battery manufacturing processes and should be easily scalable.

Also, the protective layer formed had unique advantages: simple preparation, good structural order, good film-forming effect, good stability, controllable film thickness and performance, as well as high compactness.

An advantageous effect of the interface protection afforded by the additive combination of the invention is that the energy density of secondary batteries can be significantly increased, allowing longer use of the batteries before recharging becomes necessary.

Turning now to more specific technical results as reported in Example 1 below, it was observed that the additive combination tested suppressed dendrite growth on a Li metal anode surface. In fact, a very small quantity of additives (i.e., 2% thiol compound and 1.0 mM aromatic Schiff base) significantly inhibited lithium dendrite formation.

In addition, the concentration of electrode decomposition products (LiₓPF_{y} or LiₓPO_{y}F_{z}) in the electrolyte was lowered, demonstrating that the protective layer isolated the electrolyte and inhibited electrode decomposition.

The protective layer made the Li metal surface smooth during the initial stage of Li deposition. It also provided a fast Li⁺ ion pathway and isolated the electrolyte carbonate ester solvent from the LFP and NCM cathode surfaces.

The protective layer had a lithiophilic-lithiophobic gradient structure with an outer lithiophobic portion and an inner lithiophilic portion. The outer lithiophobic portion was made of the carbon chains of the thiol compound with a dense morphology, which contributed to isolating the carbonate ester solvent and reducing the electric field effect, which in turn inhibited Li dendrites growth. The lithiophilic elements in the aromatic Schiff base molecules in the inner portion facilitated Li⁺ ion diffusion, while the lithiophobic carbon chain of the thiol compound in the outer portion regulated Li⁺ deposition and inhibited electrolyte corrosion of the Li surface.

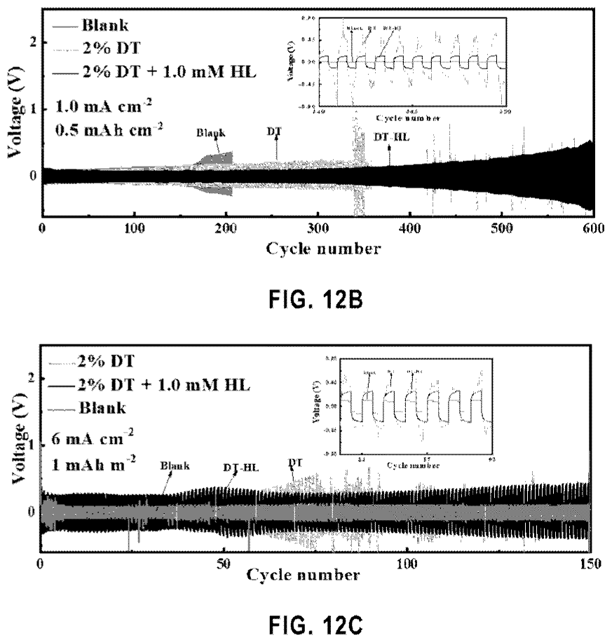

The electrochemical performances of the assembled symmetric cell were superior when the additive combination was used. The combination of the invention not only stabilized the lithium anode and reduced the decomposition of the electrolyte, but also promoted the transport of Li ions, thereby achieving high specific capacity at low current densities. Specifically, Li|Li symmetric cells using the additive combination of the invention exhibited excellent cyclic stability with 600 cycles and 150 cycles at a current density of 1.0 mA cm⁻² and 6 mA cm⁻², respectively. In contrast, the ester electrolyte with only the aromatic Schiff base had a poor cycle performance (162 cycles) at a current density of 2 mAh cm⁻² with a capacity of 1 mAh cm⁻² (see FIG. 12a). Also, the layer formed on the anode was loose and promoted the formation of Li dendrites.

It must be noted that the above advantageous effects of the additive combination of the invention are generally not observed when using the thiol compound alone or the aromatic Schiff base alone. Both components must be present to achieve most of the above good results. Otherwise, the effects are only partly achieved or not observed at all. Therefore, in that sense, the combination of additives of the invention is synergistic.

In preferred embodiments, the thiol compound and the aromatic Schiff base are present in a thiol compound/aromatic Schiff base gravimetric ratio between about 6 and about 2000 (mg/mg), preferably between about 50 and about 100 (mg/mg).

The types of electrolyte and secondary batteries envisioned will be discussed in sections. The thiol compound and the aromatic Schiff Base are described next.

### Thiol Compound

The thiol compound can be any compound that can form a self-assembled monolayer on a surface such as an electrode surface.

In embodiments, the thiol compound comprises a thiol functional group and an electrode-phobic portion, for example, a lithiophobic portion in the case of a lithium metal electrode. The electrode-phobic portion can be defined as a part of the thiol compound molecules that has less affinity for the electrode surface than the thiol group and/or as a part of the thiol compound molecules that is not attracted (preferably is repelled) by the electrode surface. Indeed, the thiol functional group is for attachment to the surface of the electrode, while the electrode-phobic portion is away from the electrode surface. In embodiments, the surface-phobic portion of the thiol compound is a hydrocarbon portion, for example a hydrocarbon chain.

In preferred embodiments, the thiol compound is of formula (1):

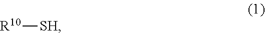

wherein R¹⁰ is a linear or branched alkyl, unsubstituted or substituted by one or more of —COOH, —SH, —C(═O)—R²⁰, —NH₂, or —O—C(═O)—R²⁰, and
wherein R²⁰ is a linear or branched alkyl, a cycloalkyl, or a heterocycloalkyl, each of which being unsubstituted or substituted by one or more of —COOH, —SH, or —C—O—R²¹, wherein R²¹ is a linear or branched alkyl.

In preferred embodiments, R¹⁰ is a linear or branched C₁-C₁₈ alkyl, and most preferably a linear or branched C₁₀-C₁₄ alkyl, and most preferably a linear or branched C₁₂ alkyl (i.e., dodecanyl).

In preferred embodiment, R¹⁰ is unsubstituted or substituted by-SH. In preferred embodiment, R¹⁰ is unsubstituted.

In embodiments, the alkyl in R²⁰ is C₁-C₁₂ alkyl.

In embodiments, the cycloalkyl in R²⁰ is a one- or two-ring cycloalkyl. In embodiments, the ring(s) of the cycloalkyl in R²⁰ comprises 5 or 6 carbon atoms.

In embodiments, the heterocycloalkyl in R²⁰ is a one- or two-ring heterocycloalkyl, preferably a one-ring heterocycloalkyl. In embodiments, the ring(s) of the heterocycloalkyl in R²⁰ comprises 5 or 6 ring atoms, preferably 5 ring atoms. In embodiments, the ring(s) of the heterocycloalkyl in R²⁰ comprises at least one heteroatom, preferably exactly one heteroatom. In embodiments, the heteroatom(s) in the heterocycloalkyl in R²⁰ is(are) nitrogen. In preferred embodiments, the heterocycloalkyl in R²⁰ is pyrrolidinyl, preferably N-pyrrolidinyl.

In embodiments, the heterocycloalkyl in R²⁰ is substituted, preferably with —COOH.

In preferred embodiments, the thiol compound is methanethiol, ethanethiol, ethanedithiol, 1-propanethiol, 1,3-propanedithiol, captopril

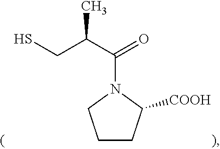

tert-dodecyl mercaptan

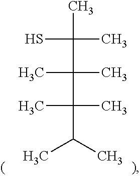

1-dodecanethiol, hexadecanethiol, 16-Mercaptohexadecanoic acid

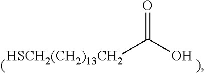

or occtadecanethiol. In most preferred embodiments, the thiol compound is 1-dodecanethiol.

### Aromatic Schiff Base

A Schiff base is a compound of formula R′N═C(R″R″′), in which R′ is a substituent other than a hydrogen atom. Schiff bases can be considered a sub-class of imines, being either secondary aldimines (wherein one or R″ and R″′ is a hydrogen atom and the other of R″ and R″′ is a substituent other than a hydrogen atom) or secondary ketimines (wherein both R″ and R″′ are substituents other than a hydrogen atom).

The aromatic Schiff base can be any aromatic Schiff base that can form a self-assembled layer on a surface of an electrode.

In preferred embodiments, the aromatic Schiff base is secondary aldimines. i.e., is of formula R′N═CH—R′″, wherein R′ and R″′ are substituents other than a hydrogen atom.

In preferred embodiments, the aromatic Schiff base is of formula (2):

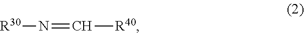

wherein R³⁰ and R⁴⁰ are independently aryl or heteroaryl, each independently unsubstituted or substituted with one or more of —OH, alkyl, a halogen atom, or a sulfur atom.

In embodiments, the aryl and/or heteroaryl in R³⁰ and R⁴⁰ are independently unsubstituted or substituted with one or more of OH, alkyl, a halogen atom, or a sulfur atom.

In preferred embodiments, the alkyl is C₁-C₁₂ alkyl, preferably C₁-C₈ alkyl.

In preferred embodiments, the halogen atom is a fluoride atom.

In embodiments, the aryl and/or heteroaryl in R³⁰ and R⁴⁰ are independently unsubstituted or substituted with up to two, preferably up to only one, of the above substituents.

In embodiments, the substituent(s) on the aryl and/or heteroaryl R³⁰ and/or R⁴⁰ are located at position 2 or 3, position 1 being the ring atom to which the secondary aldimine group (—N═CH—) is attached.

In embodiments, the substituent(s) on the aryl in R³⁰ and/or R⁴⁰ are located at position 2 or 3, more preferably at position 2, position 1 being the ring atom to which the secondary aldimine group is attached.

In embodiments, the substituent(s) on the heteroaryl in R³⁰ and/or R⁴⁰ are located at position 2 or 3, position 1 being the ring atom to which the secondary aldimine group is attached.

In preferred embodiments, the aryl or heteroaryl in R³⁰ is unsubstituted or substituted with one or more of —OH, alkyl, a halogen atom, or a sulfur atom. In more preferred embodiments, the aryl or heteroaryl in R³⁰ is unsubstituted or substituted with only one of —OH, alkyl, a halogen atom, or a sulfur atom. In most preferred embodiments, the aryl or heteroaryl in R³⁰ is unsubstituted.

In preferred embodiments, the aryl or heteroaryl in R⁴⁰ is unsubstituted or substituted with one or more —OH. In most preferred embodiments, the aryl or heteroaryl in R⁴⁰ is substituted with only one of —OH.

In embodiments, the aryl in R³⁰ and/or R⁴⁰ is a one- or two-ring aryl, preferably a one-ring aryl. In embodiments, the ring(s) of the aryl in R³⁰ and/or R⁴⁰ comprises 5 or 6 ring atoms, preferably 6 ring atoms. In preferred embodiments, the aryl in R³⁰ and/or R⁴⁰ is phenyl.

In preferred embodiments, R⁴⁰ is an aryl as described above. In most preferred embodiments, R⁴⁰ is phenyl (unsubstituted or substituted as described above). Preferably, R⁴⁰ is 2-hydroxyphenyl (1 being the point of attachment of the aryl to the secondary aldimine group).

In embodiments, the heteroaryl in R³⁰ and/or R⁴⁰ is a one- or two-ring heteroaryl, preferably a one-ring heteroaryl. In embodiments, the ring(s) of the heteroaryl in R³⁰ and/or R⁴⁰ comprises 5 or 6 ring atoms, preferably 6 ring atoms. In embodiments, the ring(s) of the heteroaryl in R³⁰ and/or R⁴⁰ comprises at least one heteroatom, preferably only one heteroatom. In embodiments, the heteroatom(s) in the heteroaryl in R³⁰ and/or R⁴⁰ is(are) nitrogen. In preferred embodiments, the heteroaryl in R³⁰ and/or R⁴⁰ is pyridinyl, preferably 2-pyridinyl.

In preferred embodiments, R³⁰ is a heteroaryl as described above. In most preferred embodiments, R³⁰ is pyridinyl, preferably 2-pyridinyl (unsubstituted or substituted as described above, preferably unsubstituted).

In yet more preferred embodiments, the aromatic Schiff base is one of the following:
2-((Pyridin-2-ylimino)methyl)phenol,
2-((3-methylpyridin-2-ylimino)methyl)phenol,
2-((4-methylpyridin-2-ylimino)methyl)phenol,
2-((4-alkylpyridin-2-ylimino)methyl)phenol,
2-((3-alkylpyridin-2-ylimino)methyl)phenol,
2-((4-fluoropyridin-2-ylimino)methyl)phenol,
2-((4-thiopyridin-2-ylimino)methyl)phenol,
2-((3-fluoropyridin-2-ylimino)methyl)phenol, or
2-((3-thiopyridin-2-ylimino)methyl)phenol.

In most preferred embodiments, the aromatic Schiff base is 2-(pyridin-2-yliminomethyl)-phenol:

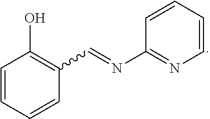 [SMILES: Oc1ccccc1C=Nc1ccccn1]

Therefore, in most preferred embodiments, the additive combination comprises 1-dodecanethiol and 2-(pyridin-2-yliminomethyl)-phenol.

### Battery Electrolyte

In another aspect of the invention, there is also provided an electrolyte for a secondary battery, the electrolyte comprising a conducting salt and the additive combination of the invention.

A method of manufacturing an electrolyte for a secondary battery is also provided. This method comprises the step of combining together the conducting salt and the additive combination of the invention. In this method, the conducting salt, the thiol compound and the aromatic Schiff base can be combined in any order.

In preferred embodiments, the electrolyte comprises between about 0.1 and about 15 v/v %, preferably between about 1 and about 5 v/v %, of the thiol compound based on the total volume of the electrolyte.

In preferred embodiments, the electrolyte comprises between about 0.1 mol L⁻¹ and about 10.0 mol L⁻¹, preferably between about 0.5 mol L⁻¹ and about 2.5 mol L⁻¹ of the of Schiff base.

In preferred embodiments, the electrolyte comprises the thiol compound and the aromatic Schiff base in a thiol compound/aromatic Schiff base gravimetric ratio between about 0.4 and about 6500, preferably between about 50 and about 100.

With the exception of the thiol compound and the aromatic Schiff base, the components of the electrolyte of the invention are the components found in conventional electrolyte for secondary batteries.

Hence, the conducting salt is any salt used in conventional battery electrolyte. In embodiments, the conducting salt can be chosen from:
LiClO₄;
LiP(CN)_{α}F_{6-α}, where α is an integer from 0 to 6, preferably LiPF₆;
LiB(CN)_{β}F_{4-β}, where β is an integer from 0 to 4, preferably LiBF₄;
LiN(CₙSₙO₂ₙ)_{γ}F_{7-γ}, where n is an integer from 1 to 20, and γ is an integer from 1 to 7; preferably LiNC₂S₂O₄F₆;
LiB(CₙO₂ₙ)F_{4-δ}, where n is an integer from 1 to 20, and δ is an integer from 1 to 4; preferably (LiBC₄O₈);
LiC(SₙO₂ₙCₙF₂ₙ₊₁)_{ε}, where n is an integer from 1 to 20, and ε is an integer from 0 to 6; preferably LiC(SO₂CF₃)₃;
salts of formula C⁺A⁻, wherein:
   C⁺ represents an alkali metal cation, such as Li⁺, Na⁺, K⁺ and combinations thereof, and
   A⁻ represents an anion such as PF₆⁻, BF₄⁻, Cl⁻, Br⁻, I⁻, ClO₄⁻, ASF₆⁻; CH₃CO₂⁻, CF₃SO₃⁻; N(CF₃SO₂)₂⁻, C(CF₂SO₂)₃⁻, and
compounds represented by the following general formulas:

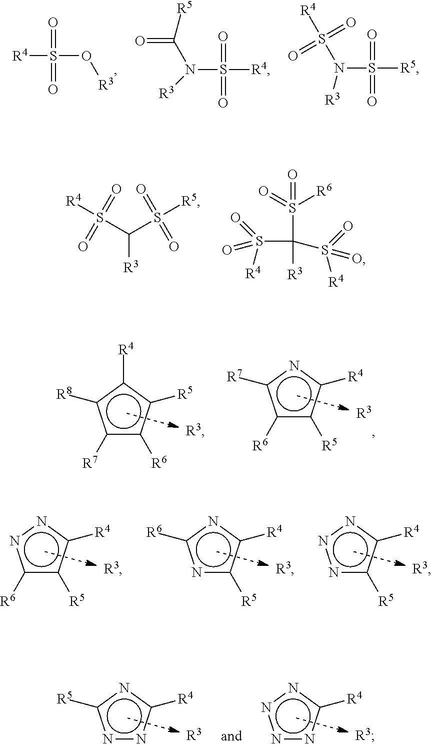

wherein
R³ represents: Li, Na, K, Rb, Cs, Be, Mg, Ca, Sr, Zn, Ba, Al, hydrogen, or an organic cation; and
R⁴, R⁵, R⁶, R⁷, R⁸ represent: cyano, fluorine, chlorine, branched or linear alkyl radical with 1-24 carbon atoms, perfluorinated linear alkyl radical with 1-24 carbon atoms, aryl or heteroaryl radical, or perfluorinated aryl or heteroaryl radical;
   and their derivatives.

In preferred embodiments, the conducting salt is a lithium salt. This is appropriate when, for example, the electrolyte will be used in a lithium battery, such as a lithium metal battery or a lithium-ion battery. Non-limiting examples of lithium salts include the above salts, preferably lithium perchlorate, lithium tetrafluoroborate, lithium hexafluorophosphate, lithium sulfonyl amide salts (such as lithium bis(fluorosulfonyl)amide, lithium N-flurosulfonyl-trifluoromethanesulfonyl amide (LIFTFSI), and lithium bis(trifluoromethanesulfonyl)amide) and their derivatives. In preferred embodiments, the conducting salt is lithium hexafluorophosphate

In alternative embodiments, the salt is a sodium, a potassium, calcium, aluminum, magnesium or zinc salt such as those listed above. This is appropriate when, for example, the electrolyte is to be used in a sodium-, potassium-, calcium-, aluminum-, magnesium-, or zinc-based battery.

In embodiments, the electrolyte is a solid electrolyte.

In preferred alternative embodiments, the electrolyte is a liquid electrolyte. In such embodiments, the salt is liquid and/or the electrolyte comprises a solvent. Any solvent used in conventional battery electrolyte can be used. Non-limiting examples of solvents include:
cyclic and linear carbonates such as propylene carbonate (PC), ethylene carbonate (EC), diethyl carbonate (DEC), butylene carbonate (BC), dimethyl carbonate (DMC), dipropyl carbonate (DPC), methylpropyl carbonate (MPC), and ethylpropyl carbonate (EPC), and fluoroethylene carbonate (FEC),
propionate-based compounds such as ethyl propionate (EP), propyl propionate (PP), n-propyl propionate, isopropyl propionate, n-butyl propionate, isobutyl propionate, and tert-butyl propionate, as well as
other solvents such as dimethyl sulfoxide, acetonitrile, dimethoxyethane, diethoxyethane, tetrahydrofuran, ethylmethyl carbonate (EMC), and gamma-butyrolactone (GBL).
   Mixtures of those solvents can also be used. More preferred solvents include EC, DEC, DMC, EMC, and FEC.

The choice of solvent and salt will vary depending on the type of battery. If the battery is a lithium-ion battery, it would be more appropriate to choose, for example, an electrolyte comprising lithium salt, such as a lithium sulfonyl amide salt as a conducting salt. However, if the battery is a sodium-based battery, it would be more appropriate to choose, for example, an electrolyte comprising a sodium salt as a conducting salt.

In addition, the electrolyte may optionally further comprise one or more other additives typically found in conventional electrolytes. Such other additives are used to improve the electrochemical properties of the electrolyte. Non-limiting examples of other additives that improve the electrochemical properties of the electrolyte include:
agents that improve solid electrolyte interphase (SEI) and cycling properties,
agents that promote uniform deposition of lithium ions,
agents that form a stable cathode electrolyte interphase (CEI) film on cathode electrode surface,
unsaturated carbonates that improve stability at high and low voltages, and
organic solvents that diminish viscosity and increase conductivity.

It will be understood by the skilled person that one of these other additives can have more than one specific technical effect on the electrolyte and thus may be cited in more than one of the below lists of exemplary additives with different preferred concentration ranges according to the effect desired of the additive.

Agents that improve solid electrolyte interphase and cycling properties are preferably present in the electrolyte. Non-limiting examples of agents that improve solid electrolyte interphase and cycling properties include ethylene carbonate, vinylene carbonate, fluorovinylene carbonate, succinic anhydride, maleic anhydride, fluoroethylene carbonate, difluoroethylene carbonate, methylene-ethylene carbonate, prop-1-ene-1,3-sultone, acrylamide, fumaronitrile, and triallyl phosphate. Preferred agents that improve solid electrolyte interphase and cycling properties include vinylene carbonate (VC) and fluoroethylene carbonate (FEC).

Agents that promote uniform deposition of lithium ions are optionally present in the electrolyte. Non-limiting examples of agents that promote uniform deposition of lithium ions include crown ether, hexadecyl trimethylammonium chloride, cobalt phthalocyanine, octaphenyl polyoxyethylene, polytitanosiloxane, sulfur dioxide and carbon dioxide. Preferred agents that promote uniform deposition of lithium ions include octaphenyl polyoxyethylene.

Agents that form a stable cathode electrolyte interphase (CEI) film on cathode electrode surface are optionally present in the electrolyte. Non-limiting examples of agents that form a stable cathode electrolyte interphase (CEI) film on cathode electrode surface include inylene carbonate, lithium carbonate, thiophene, pyrrole, diphenyl ether, tris (pentafluorophenyl) borane, ethyl vinyl phosphate, tetraethoxysilane, tetrapropoxysilane, tetramethoxysilane and fluoroethylene carbonate. Preferred agents that form a stable cathode electrolyte interphase (CEI) film on cathode electrode surface include fluoroethylene carbonate.

Unsaturated carbonates are optionally present in the electrolyte. Non-limiting examples of unsaturated carbonates that improve stability at high and low voltages include vinylene carbonate and derivatives of ethene (that is, vinyl compounds) like methyl vinyl carbonate, divinylcarbonate, and ethyl vinyl carbonate.

Organic solvents that diminish viscosity and increase conductivity are optionally present in the electrolyte. In preferred embodiments, such organic solvents are present. Non-limiting examples of organic solvents that diminish viscosity and increase conductivity include polar solvents, preferably alkyl carbonates, alkyl ethers, and alkyl esters. For example, the organic solvent may be ethylene carbonate, propylene carbonate, dimethyl carbonate, ethyl methyl carbonate, diethyl carbonate, dimethoxyethane, diglyme (diethylene glycol dimethyl ether), triglyme (triethylene glycol dimethyl ether), tetraglyme ((tetraethylene glycol dimethyl ether), tetrahydrofuran, 2-methyltetrahydrofuran, 1,3-dioxolane, 2,2-dimethyl-1,3-dioxolane, 1,4-dioxane, 1,3-dioxane, methoxypropionitril, propionitril, butyronitrile, succinonitrile, glutaronitrile, adiponitrile, esters of acetic acid, esters of propionic acid, cyclic esters like γ-butyrolactone, ε-caprolactone, esters of trifluoroacetic acid, sulfolane, dimethyl sulfone, ethyl methyl sulfone, or peralkylated sulfamides. In embodiments, ionic liquids could also be added in order to diminish flammability and to increase conductivity. Preferred organic solvents that diminish viscosity and increase conductivity include ethylene carbonate (EC), dimethyl carbonate (DMC), ethyl methyl carbonate (EMC) and diethyl carbonate (DEC).

Other non-limiting examples of additives that can be present in the electrolyte of the invention include:
Cobalt Phthalocyanine,
Ferrocene,
Crown ether,
Trimethyl phosphate,
Methyl dimethyl phosphate,
Vitamin A,
lithium tetrafluoroborate,
lithium perchlorate, and
lithium bisoxalato borate.

### Secondary Battery

In another aspect of the invention, there is provided a secondary battery comprising an anode, a cathode, and the electrolyte of the invention as described above between the anode and the cathode.

There is also provided the use of the electrolyte of the invention as described above in a secondary battery. Furthermore, a method of manufacturing a secondary battery is provided. This method comprises the steps of assembling together an anode, a cathode, and the electrolyte of the invention as described above between the anode and the cathode.

In the battery, at least one electrode surface bears a layer comprising the thiol compound and the aromatic Schiff base provided by the electrolyte of the invention. Because the sulfur atom in the —SH group and the nitrogen atom of the secondary aldimine group contain a lone pair of electrons, which can easily form Li—S and Li—N bonds with lithium metal and other surfaces, e.g. sodium and zinc, which have very low potentials. The electrode surface can be either or both the anode surface and the cathode surface. In preferred embodiment, the layer is on at least a lithium metal surface of an electrode.

The thiol compound and the aromatic Schiff base advantageously self-assemble to form the layer on the surface of the electrode. In embodiments, the thiol compound adsorbs on the electrode surface via its thiol group. In embodiments, the aromatic Schiff base adsorbs on the electrode surface via the nitrogen atom of its secondary aldimine group (—N═CH—) and the oxygen atom of —OH group (if such a group is present).

Since the layer is on a surface of the electrode, it can be said that it has an electrode side and an electrolyte side. In embodiments, the layer is comprised of an outer electrode-phobic portion on the electrolyte side and an inner electrode-philic portion on the electrolyte side. In preferred embodiments, the outer portion of the layer comprises the electrode-phobic portion of the thiol compound molecules (said electrode-phobic portion being as described in a previous section) and the inner portion of the layer comprises aromatic Schiff base molecules and the remainder of the thiol compound molecules. In effect, in embodiments, the layer presents a gradient of affinity with the surface. In embodiments, in which the electrode is a lithium metal electrode, the electrode-phobic portion of the thiol compound is lithiophobic, the outer electrode-phobic portion of the layer is lithiophobic and the inner electrode-philic portion of the layer is lithiophilic.

In Example 1 below, the outer layer flattened the Li anode surface, repelling Li⁺ ions and reducing the space charge effect. The inner layer regulated the deposition of repelled Li⁺ ions and promoted Li uniform nucleation.

It is believed that the aromatic Schiff base first adsorbs and then the thiol compound fills in the gap between the aromatic Schiff base molecules as well as any pit in the electrode surface. In embodiments, the layer fills in pits in the electrode surface.

In embodiments, the layer is about 5 to about 150 nm thick, preferably about 60 to about 85 nm thick, and most preferably about 76.5 nm thick.

The secondary battery can be any known secondary battery. As such, they can be manufactured according to methods known in the art. Such secondary batteries include, for example:
lithium batteries such as lithium metal batteries, lithium-ion batteries, lithium-air batteries, lithium polymer batteries, lithium-ion polymer batteries,
sodium batteries such as sodium metal batteries, sodium-ion batteries, sodium-air batteries, sodium polymer batteries, sodium-ion polymer batteries,
potassium batteries such as potassium metal batteries, potassium-ion batteries, potassium-air batteries, potassium polymer batteries, potassium-ion polymer batteries,
magnesium batteries such as magnesium metal batteries, magnesium-ion batteries, magnesium-air batteries, magnesium polymer batteries, magnesium-ion polymer batteries,
aluminum batteries such as aluminum metal batteries, aluminum-ion batteries, aluminum polymer batteries, aluminum-ion polymer batteries, and
zinc batteries such as aqueous zinc ion batteries, nonaqueous zinc ion batteries, zinc-air batteries, zinc polymer ion batteries.

In preferred embodiments, the battery, is a lithium battery, a lithium-ion battery, a sodium battery, a sodium-ion battery, a potassium battery, a potassium-ion battery, a magnesium battery, a magnesium-ion battery, a zinc battery, or a zinc ion battery. More preferably, a lithium metal battery.

In embodiments, the secondary battery further comprises a separator in the electrolyte between the anode and the cathode. Indeed, in order to prevent physical contact between electrodes, a separator membrane is usually placed between them. The separator membrane can be any separator membrane typically used for a battery.

In preferred embodiments, the separator membrane is one that is suitable for a lithium or a lithium-ion battery. Another function of such a separator membrane is to prevent lithium dendrite from causing a short-circuit between electrodes. Such separator membranes typically include (i) a polyolefin based porous polymer membrane, preferably made of polyethylene “PE”, polypropylene “PP”, or a combination of PE and PP, such as a trilayer PP/PE/PP membrane; (ii) heat-activatable microporous membranes; (iii) porous materials made of fabric including glass, ceramic or synthetic fabric (woven or non-woven fabric); (iv) porous membranes made of polymer materials such as poly(vinyl alcohol), poly(vinyl acetate), cellulose, and polyamide; (v) porous polymeric membranes provided with an additional ceramic layer in order to improve the performance at high potentials; and (vi) polymer electrolyte membranes. However, as mentioned, the separator membrane can also be any separator membrane typically used for a battery, preferably for a lithium or a lithium ion battery; for example, Celgard 3501™ or Celgard Q20S1HX™.

In embodiments, the electrolyte is solid, thus the secondary battery is a so-called all-solid battery.

In preferred embodiments, the electrolyte is liquid.

The anode can be any such electrode that can be used in conventional secondary batteries. There is no particular limitation in selection of the anode active material. In preferred embodiments, the anode is one that is suitable for a lithium or a lithium-ion battery, e.g., it can be made of a material capable of lithium-ion intercalation/deintercalation. Anodes are usually made of Li metal, carbonaceous materials (graphite, coke, and hard carbon), silicon and its alloys, tin and its alloys, antimony and its alloys, lithium titanate (Li₄Ti₅O₁₂), inorganic oxides, inorganic chalcogenides, nitrides, metal complexes or organic polymer compounds. These materials are usually mixed with a solvent, a polymer binder and electro-conductive additives—which include various forms of conductive carbon, such as carbon nanotubes and carbon black—and subsequently coated on a copper current collector in order to obtain the anode. In preferred embodiments, the anode is made of Li metal.

The cathode can be any such electrode that can be used in conventional secondary batteries. There is no particular limitation in selection of the cathode active material. In preferred embodiments, the cathode is one that is suitable for a lithium or a lithium-ion battery. Such cathodes usually comprise lithium compounds. These lithium compounds are usually mixed with a solvent, polymer binder and electro-conductive additives—which include various forms of conductive carbon, such as carbon nanotubes and carbon black—and subsequently coated on a current collector in order to obtain the cathode. This can be, for example, lithiated oxides of at least one element selected from the group consisting of alkali metals, alkaline earth metals, Group 13 elements, Group 14 elements, Group 15 elements, transition metals and rare earth elements or lithium compounds with transition metals and complex anions. Non-limiting examples of the cathode active material include various types of lithium transition metal composite oxides (for example, lithium manganese composite oxides such as LiMn₂O₄; lithium nickel oxides such as LiNiO₂; lithium cobalt oxides such as LiCoO₂; lithium iron oxides; the above-described oxides in which manganese, nickel, cobalt or iron is partially doped or substituted with other transition metals or non-transition metals (for example, Al, Mg, Zr, Fe, Zn, Ga, Si, Ge or combinations thereof, including compounds such as LiCoₓN₁₋ₓO₂ wherein the x is from 0.1 to 0.9, LMN (LiMn_{3/2}Ni_{1/2}O₄), LMC (LiMnCoO₂), LiCuₓMn₂₋ₓO₄, NMC (LiNiₓMn_{y}Co_{z}O₂), NCA (LiNiₓCo_{y}Al_{z}O₂)); lithium-containing vanadium oxides; and chalcogenides (for example, manganese dioxide, titanium disulfide, molybdenum disulfide, and lithium compounds with transition metals and complex anions, LFP (LiFePO₄), LNP (LiNiPO₄), LMP (LiMnPO₄), LCP (LiCoPO₄), Li₂FCoPO₄; LiCo_{q}FeₓNi_{y}Mn_{z}PO₄, and Li2MnSiO4, etc.) In preferred embodiments, the cathode are made of LifePO₄ or LiNi_{0.8}Co_{0.1}Mn_{0.1}O₂.

The choice of anode, cathode, and separator membrane, among those provided above as well as others known in the art, will vary depending on the type of battery and be selected as known by the skilled person.

### Electrode

In another aspect of the invention, there is also provided an electrode having a surface and comprising a layer on said surface, wherein said layer comprises the thiol compound and the aromatic Schiff base and is as described in the previous section.

Furthermore, a method of manufacturing an electrode. This method comprises the steps of allowing the thiol compound and the aromatic Schiff base as described in the previous sections to self-assembled on a surface of said electrode to form a layer as described in the previous section.

In preferred embodiments, the layer comprises the thiol compound and the aromatic Schiff base in a thiol compound/aromatic Schiff base gravimetric ration between about 6 and about 2000 (mg/mg), preferably between about 50 and about 100 (mg/mg).

In embodiments, the electrode is an anode as described in the previous section.

In embodiments, the electrode is a cathode as described in the previous section.

In embodiments, the electrode is for use with an electrolyte in a secondary battery.

In embodiments, the electrolyte comprises a conducting salt and optionally other components such as additives and a solvent, all being as described in the section entitled “Other components of the electrolytes” above.

In embodiments, the electrolyte is a liquid electrolyte.

In preferred alternative embodiments, the electrolyte is a solid electrolyte.

The secondary battery can be any known secondary battery. As such, they can be manufactured according to methods know in the art. Such secondary batteries include, for example, those listed in the previous section, including the preferred embodiments thereof.

In embodiments, the secondary battery further comprises a separator, the separator being as described above.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

Similarly, herein a general chemical structure, such as Formulas 1 and 2, with various substituents (R₁, R₂, etc.) and various radicals (alkyl, halogen atom, etc.) enumerated for these substituents is intended to serve as a shorthand method of referring individually to each and every molecule obtained by the combination of any of the radicals for any of the substituents. Each individual molecule is incorporated into the specification as if it were individually recited herein. Further, all subsets of molecules within the general chemical structures are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Herein, the terms “alky”, “alkylene”, “alkeny”, “alkenylene”, “alkyny”, “alkynylene” and their derivatives (such as alkoxy, alkyleneoxy, etc.) have their ordinary meaning in the art. For more certainty, herein:

| | |
|---|---|
| Term | Definition |

Saturated aliphatic hydrocarbons

| | |
|---|---|
| alkane | aliphatic hydrocarbon of general formula CₙH₂ₙ₊₂ |
| alkyl | monovalent alkane radical of general formula —CₙH₂ₙ₊₁ |

It is to be noted that, unless otherwise specified, the hydrocarbon chains of the above groups can be linear or branched. Further, unless otherwise specified, these groups can contain between 1 and 18 carbon atoms, more specifically between 1 and 12 carbon atoms, between 1 and 6 carbon atoms, between 1 and 3 carbon atoms, or contain 1 or 2, preferably 1, or preferably 2 carbon atoms.

Herein, the terms “cycloalkyl”, “aryl”, “heterocycloalkyl”, “heteroaryl”, and “methylene” have their ordinary meaning in the art. For more certainty, herein:

| Term | Definition |
|---|---|
| cycloalkane | monovalent saturated aliphatic hydrocarbon radical of |
| | general formula CₙH₂ₙ, wherein the carbon atoms are |
| | arranged in a ring (also called cycle). |
| cycloalkyl | monovalent cycloalkane radical |
| heterocycloalkane | cycloalkane wherein at least one of the carbon atoms is |
| | replaced by a heteroatom. |
| heterocycloalkyl | monovalent heterocycloalkyl radical |
| arene | aromatic hydrocarbon presenting alternating double |
| | and single bonds between carbon atoms arranged in |
| | one or more rings. |
| aryl | monovalent arene radical |
| heteroarene | arene wherein at least one of the carbon atoms forming |
| heteroaryl | the ring(s) is replaced by a heteroatom monovalent |
| | heteroarene radical |

It is to be noted that, unless otherwise specified, each ring of the above groups can comprise between 4 and 8, preferably 5 or 6 ring atoms.

Also, each of the above compound may comprise more than one ring. In other words, they can be polycyclic. Polycyclic arenes are composed of multiple aromatic rings (organic rings in which the electrons are delocalized). Polycyclic arenes comprise fused aromatics. These are compounds that comprise two or more aromatic rings fused together by sharing two neighboring carbon atoms. The simplest such compounds are naphthalene, having two aromatic rings, and the three-ring compounds anthracene and phenanthrene. Polycyclic arenes also comprise compounds in which aromatic rings are attached to each other via a covalent bond or a carbon atom (bearing 0, 1, or 2 hydrogen atoms as needed depending on the number of aromatic rings to which it is attached).

Herein, at “heteroatom” is an atom other than a carbon atom or a hydrogen atom. Preferably, the heteroatom is oxygen or nitrogen.

Herein, a “ring atom”, such as a ring carbon atom or a ring heteroatom, refers to an atom that forms (with other ring atoms) a ring of a cyclic compound, such as a cycloalkyl, an aryl, etc.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1—Dual Electrolyte Additives Derived Mixed Self-Assembled Molecular Film for Dendritic-Free Lithium Metal Battery

Herein, we describe a self-assembled strategy to create an asymmetric, robust, and bright molecular self-assembled Li plating layer via adding dual additives in a commercial ester electrolyte system. More specifically, we report a novel mixed self-assembled molecular layer (MSAM) strategy using 1-dodecanethiol (DT) and 2-(Pyridin-2-yliminomethyl)-phenol (HL) dual electrolyte additives in an ester-based electrolyte system to achieve protection layers on both the anode and the cathode surface (named MSAM_{HL/DT}).

This MSAM_{HL/DT} has a lithiophilic-lithiophobic gradient structure and makes the Li metal surface smooth at the initial stage of Li deposition while providing a fast Li⁺ ion pathway and isolating carbonate solvent on LFP or NCM cathode surface. Indeed, due to Van der Waals forces of the carbon chain, the MSAM_{HL/DT} external layer of lithiophobic carbon chains with a dense morphology isolates carbonate solvent and reduces the electric field effect, which inhibit Li dendrites growth. Indeed, a very small quantity of our dual-additives (i.e., 2% 1-dodecanethiol and 1.0 mM 2-(Pyridin-2-yliminomethyl)-phenol), significantly inhibits lithium dendrite formation.

Furthermore, the MSAM_{HL/DT} internal layer with lithophilic elements such as N, O and S promotes Li⁺ ion diffusion while ensuring the stable adsorption of MASM_{HL/DT} on both the Li and cathode surfaces.

Finally, the DT and HL materials are compatible with the commercial electrolytes and can be used directly in current commercial batteries, which will ease the commercial development of LMBs.

Moreover, a lithium|lithium symmetric cells exhibited excellent cyclic stability with 600 cycles and 150 cycles at a current density of 1.0 mA cm⁻² and 6 mA cm⁻², respectively.

Assembled Li|LiFePO₄ (LFP) full cells exhibited a specific capacity of 99.6 mAh g⁻¹ at 2.0 C after 100 cycles under lean electrolyte condition. In fact, the LFP full cell displayed excellent cyclic performance: after 800 cycles, it showed a specific capacity of 98.5 mAh g⁻¹ at a current density of 2 C, and it delivered a high specific capacity of 100 mAh g⁻¹ after 100 cycles even in the lean electrolyte condition.

X-ray absorption near-edge spectroscopy (XANES), extended X-ray absorption fine structure (EXAFS), X-ray photoelectron spectroscopy (XPS) and density functional theory (DFT) calculations were used to reveal the protection mechanism of MASM_{HL/DT}.

### Materials and Methods

Materials: 1-dodecanethiol was received from Fisher Scientifique Canada. Schiff base was prepared by the following steps: first, 2-amino pyridyl derivatives was solved in methanol, and then salicylaldehyde was added with constant stirring under nitrogen and then refluxed for 5-20 h. The reaction was monitored by thin layer chromatography plates. After completion, the reaction mixtures were cooled and the solvent was evaporated to give the crude products, which were recrystallized from ethanol to afford pure compounds. LiFePO₄ was obtained from Shanghai Darui Fine Chemical Co., Ltd. The 1 mol L⁻¹ LiPF₆ in a mixture of ethylene carbonate (EC) and ethyl methyl carbonate (EMC), which was obtained from Sigma-Aldrich Co., Ltd.

Characterization: The morphology of Li foil was examined by scanning electron microscope (SEM). XPS experiments were undertaken using monochromatic 1486.6 eV Al Kα radiation. Li K-edge and P and S L-edge XANES measurements were conducted at the Variable Line Spacing Plane Grating Monochromator (VLS-PGM) beamline at the Canadian Light Source (Saskatoon, Canada).

Electrochemical Measurements: All the assembled batteries were operated in an ester-based electrolyte.

To illustrate the electrochemical cycling performance of the electrolyte with DT additive or DT-HL dual-additives, symmetric LiLi coin cells were manufactured in a glove box. The symmetric coin cells underwent cyclic plating/stripping and galvanostatic testing at room temperature with current densities of 1.0, 2.0, and 4.0 mA cm⁻², respectively. The working electrode and counter electrode were both Li foil.

To study the electrochemical performance of the Li|LFP (NCM) full-cell, LFP (NCM) and Li foil were used as cathode and anode, respectively. To prepare the LFP (NCM) cathode, LFP (NCM) powder was mixed with carbon black and polyvinylidene fluoride using N-methyl-2-pyrrolidone as the solvent to form a homogenous slurry. The resultant slurries were uniformly coated onto Al foils. The cut-off potentials of charge and discharge were measured at 4.2 and 2.5 V (vs. Li⁺/Li) in Li|LiFePO₄ full-cell. The cut-off potentials of charge and discharge were measured at 4.7 and 3.0 V (vs. Li⁺/Li) in Li|LiNi_{0.8}Co_{0.1}Mn_{0.1}O₂ full-cell. Impedance measurements were performed using a CHI electrochemical workstation with a signal amplitude of 5.0 mV over the frequency range of 100 kHz to 0.01 Hz. The capacitance can be calculated by the following equation: C=(2πfZᵢₘ)⁻¹, where C is the capacitance, Zᵢₘ is the imaginary component of the impedance, and f is the frequency of the ac perturbation.

### Results and Discussion

### Characterization of the Li Deposition

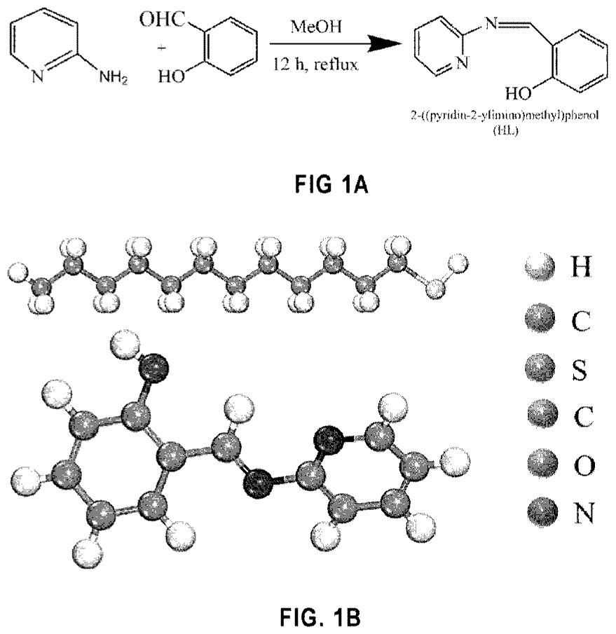

The preparation progress of Schiff base HL and the molecular structure of DT and HL are shown in FIG. 1.²² The preparation progress of Schiff base HL was conducted by standard procedures at the condition of the inert gas nitrogen (N₂), as displayed in FIG. 1a. Moreover, FIG. 1b exhibits the molecular structure of DT and HL. The N, O elements in the HL molecular structure contains a lone pair of electrons, which can react with lithium metal to be adsorbed on the lithium surface.

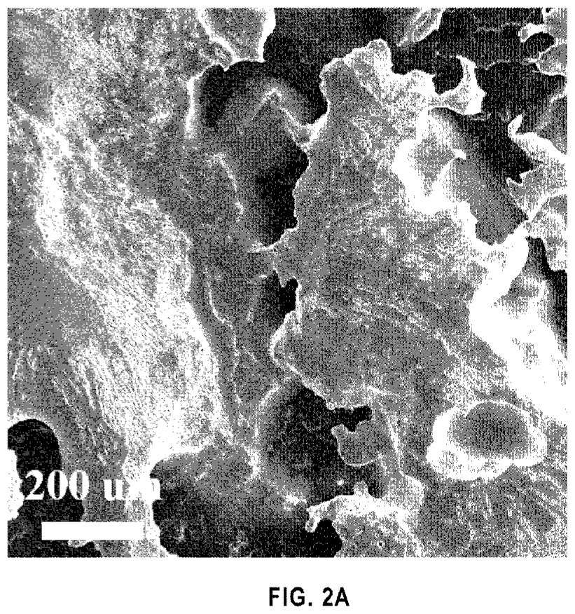

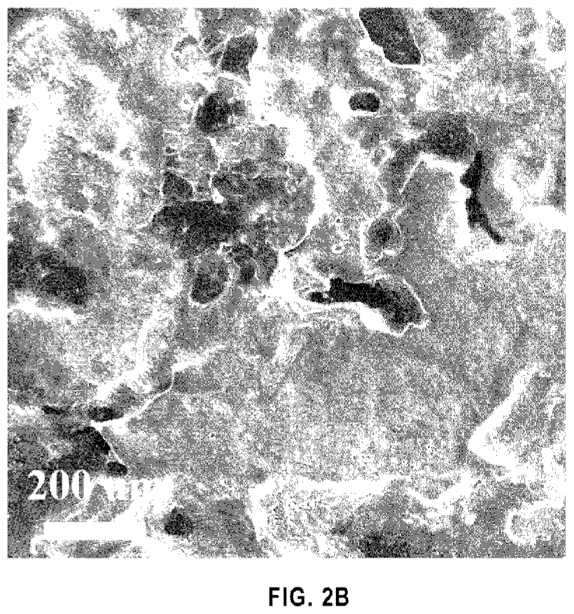

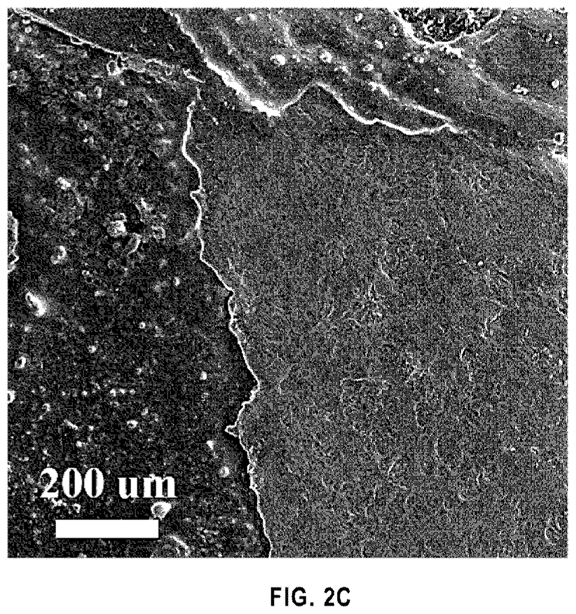

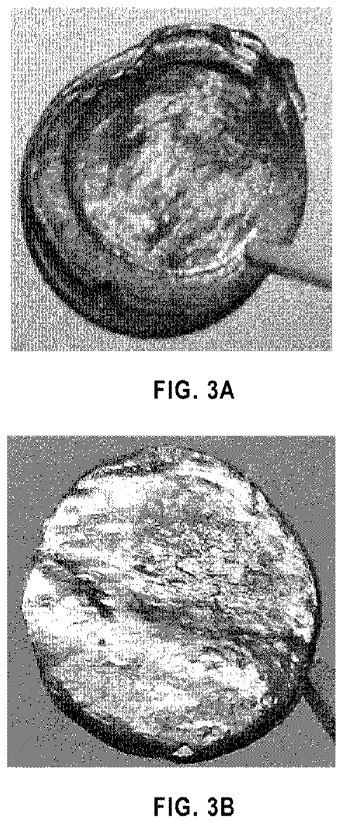

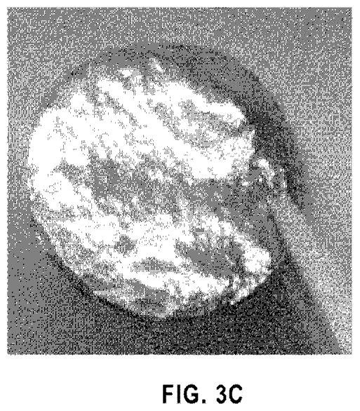

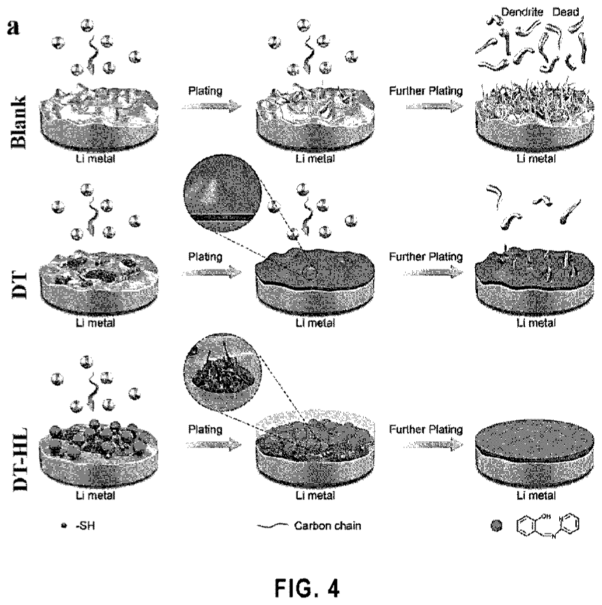

FIG. 2 shows the Li surface morphology when Li metal is immersed in different electrolyte systems. In the blank electrolyte system (FIG. 2a), after 1^{st} cycle at a current density of 1 mA cm⁻², large holes on the Li metal surface are observed, which are due to the uneven Li deposition and the formation of the rough, uneven and dark Li surface (FIG. 3a). This surface promoted electrolyte decomposition and Li dendrites formation during Li plating/stripping progress. (FIG. 4).

When the 2% single DT additive is introduced into the electrolyte, the DT molecules fill the holes to a certain extent (FIG. 2b), but the Li dendrites still grow during the extended cycles (FIG. 4). This is because DT additive only forms a local semi-bright, sparse and porous single self-assembled molecular layer (SSAM_{DT}), leading to the production of a new rugged surface during extended cycles (FIG. 3b).

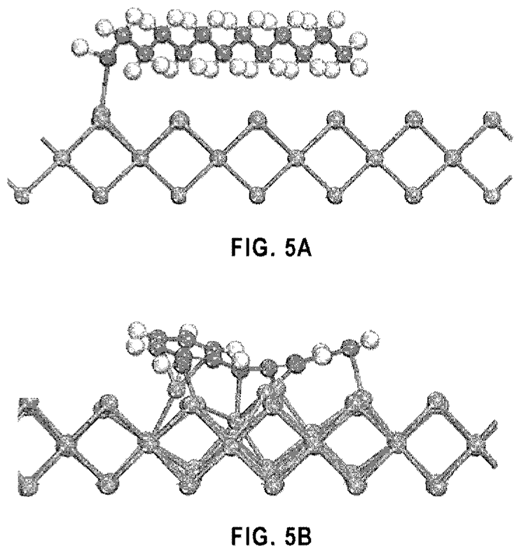

When 2% DT and 1.0 mM HL (DT-HL) are used as complementary additives in the ester electrolyte system, a dense, bright and smooth MSAM_{HL/DT} is produced on the Li surface (FIG. 2c and FIG. 3c). Because HL molecules exhibit a higher adsorption energy than the DT molecules (FIG. 5a-b, and 6), the HL molecules preferentially adsorb on the Li surface. Then, the DT molecules modify the gaps in the HL layer while filling the pits on the Li surface to produce a dense MSAM_{HL/DT} film (FIG. 4).

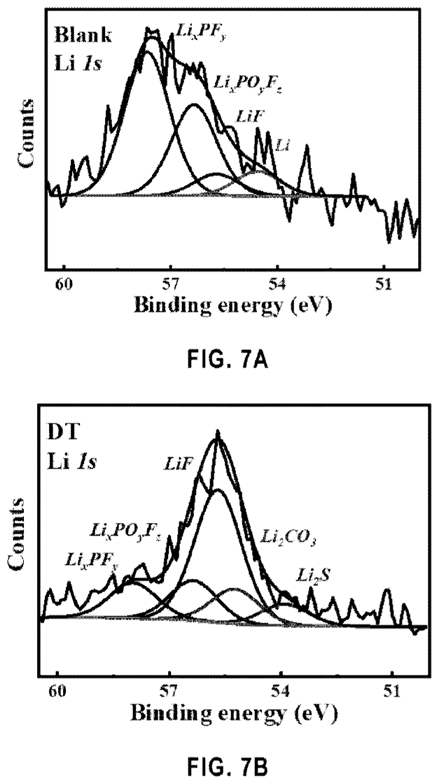

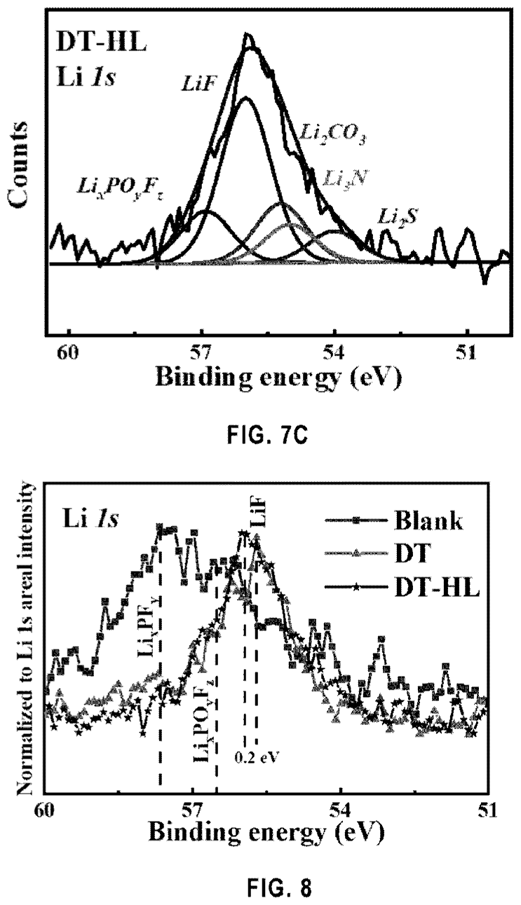

X-ray photoelectron spectroscopy (XPS) experiments were conducted to verify the adsorption of DT and DT-HL additives (FIG. 7a-c). The characteristic peaks of Li₂S and Li₃N are detected in the Li 1s XPS spectrum, which indicates that the additives are well adsorbed on the Li surface.^{23,24} In addition, the intensity of LiₓPF_{y} or LiₓPO_{y}F_{z} in the electrolytes containing DT and DT-HL additives is lower than that in the blank electrolyte, demonstrating the SAM layer isolates the carbonate and inhibits electrolyte decomposition (FIG. 7a-c and FIG. 8).²⁵

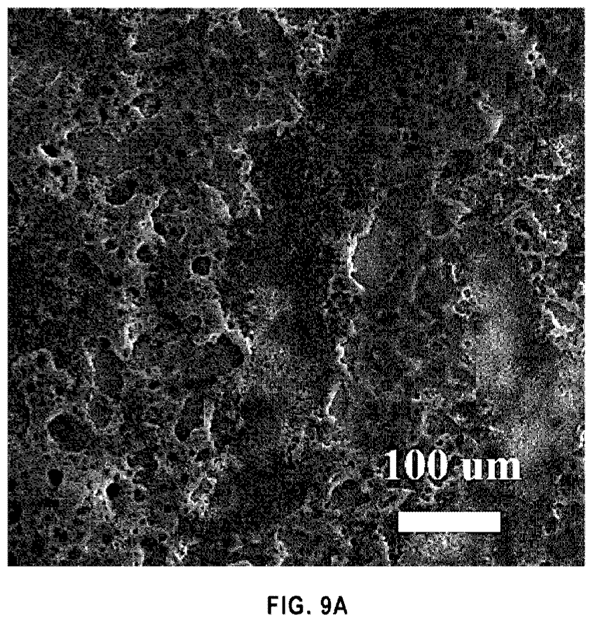

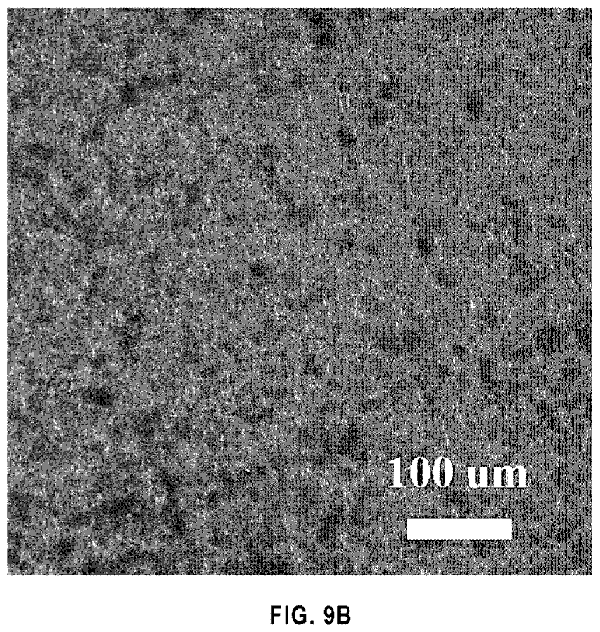

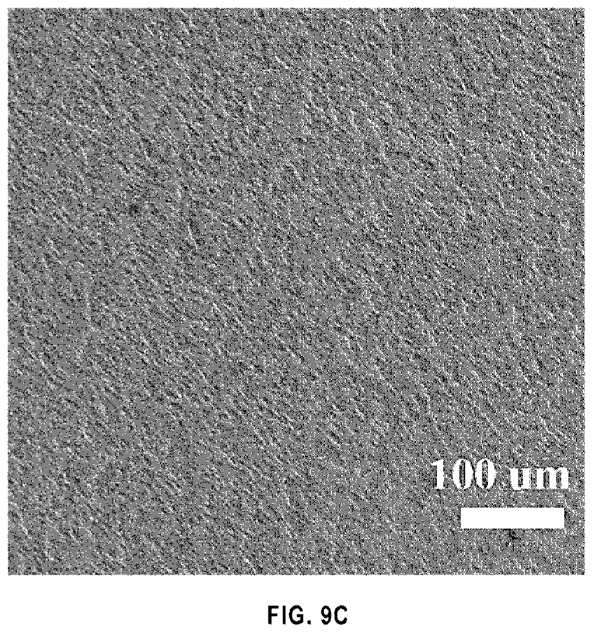

To demonstrate the effect of DT-HL dual-additives on Li plating behavior at the initial state, scanning electron microscope (SEM) characterizations were performed to investigate the Li deposition on Cu foil at a current density of 0.5 mA cm⁻² with a capacity of 6 mAh cm⁻² in different electrolyte systems. In the blank electrolyte, as exhibited in FIG. 9a, many holes and large cracks are formed due to the highly uneven Li deposition. This kind of rough Li surface can cause the continuous decomposition of electrolytes and the formation of Li dendrites. When the DT additive was added to the electrolyte, some small holes remained due to the poor compactness of SSAM_{DT} layer. These holes created a new rough and uneven surface and resulted in Li dendrites formation (FIG. 9b). In contrast, the electrolyte with DT-HL dual-additives generated a dense MSAM_{HL/DT} layer without any imperceptible cracks on the Li surface (FIG. 9c). The HL molecules preferentially adsorbed on the Li surface inducing the deposition of Li⁺ and making the Li nucleate uniformly. Then, the DT molecules adsorbed on the Li surface due to the close packing of the lithiophobic carbon chains, which generated a smooth Li surface. Therefore, under the synergistic effect of HL and DT molecules, the MSAM_{HL/DT} film promoted the uniform deposition of Li⁺ ions and inhibited Li dendrites growth.

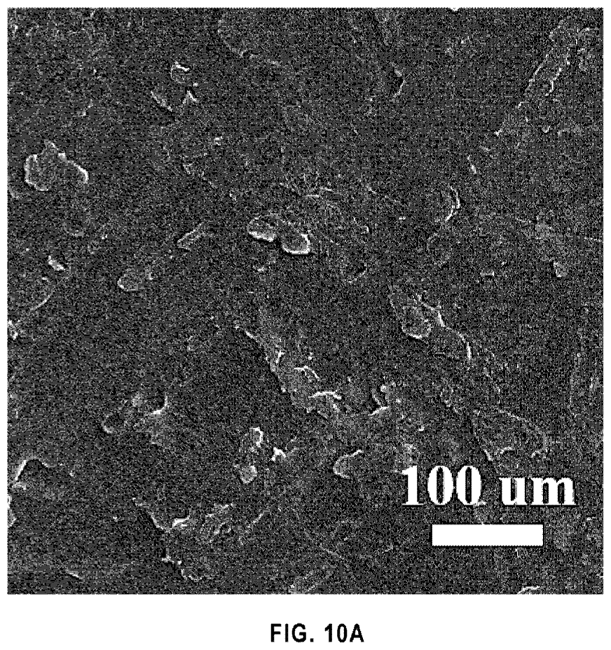

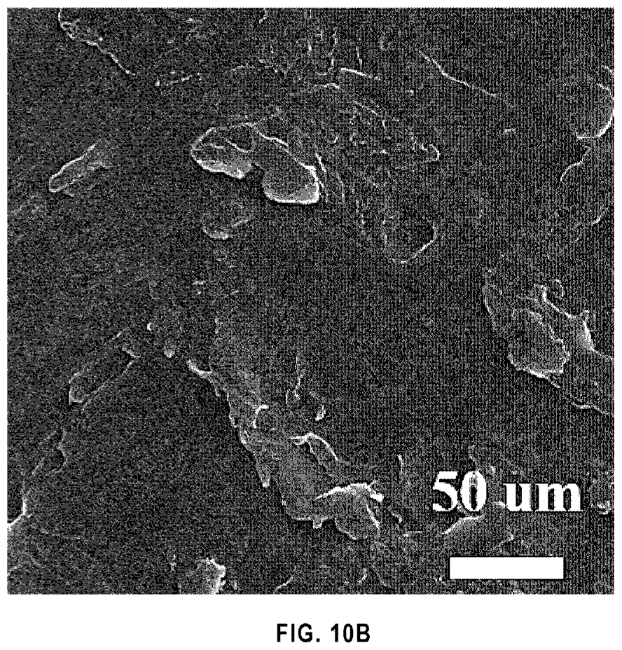

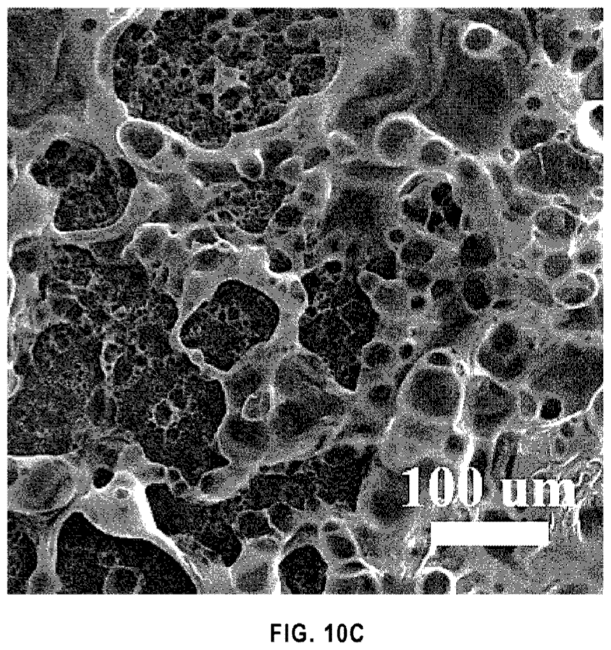

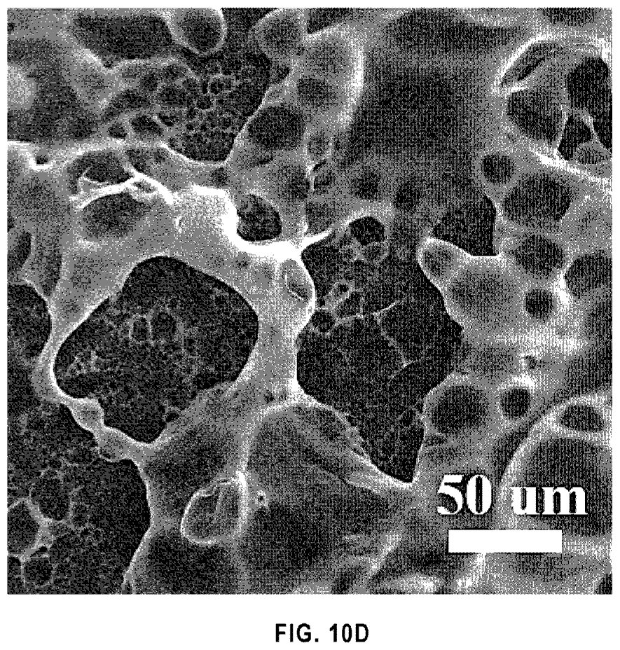

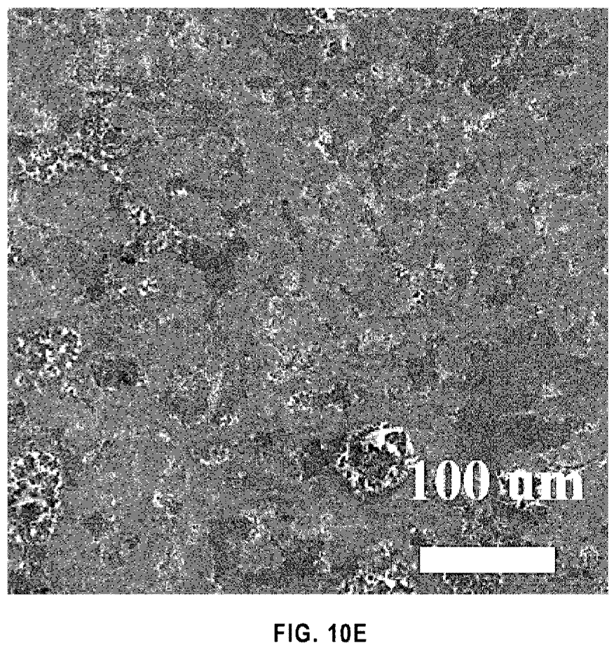

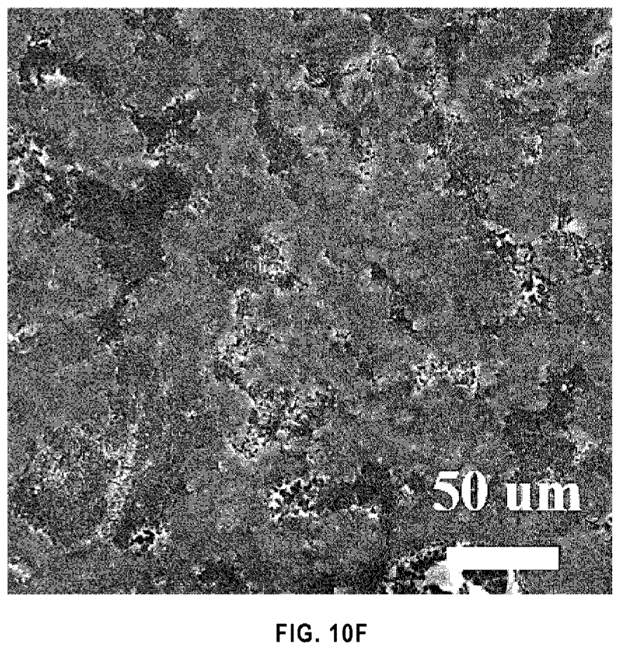

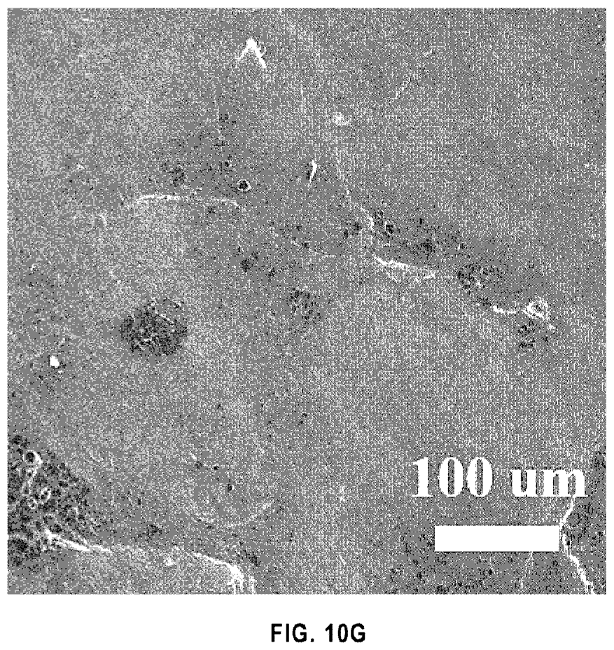

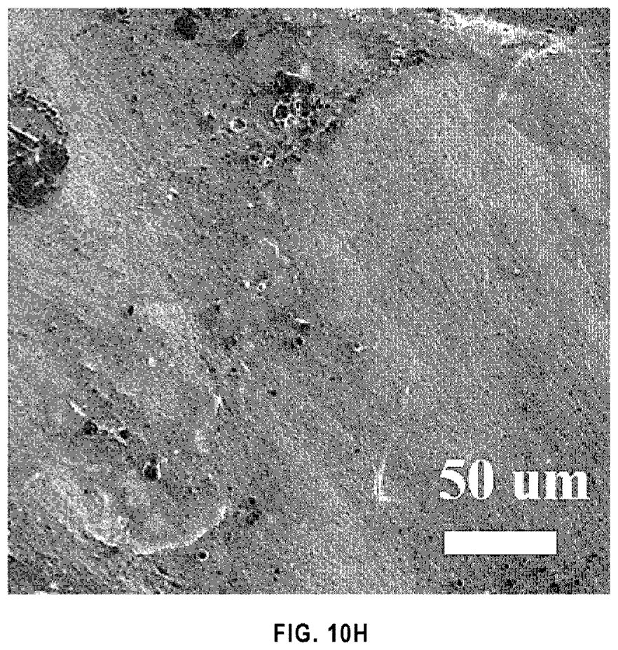

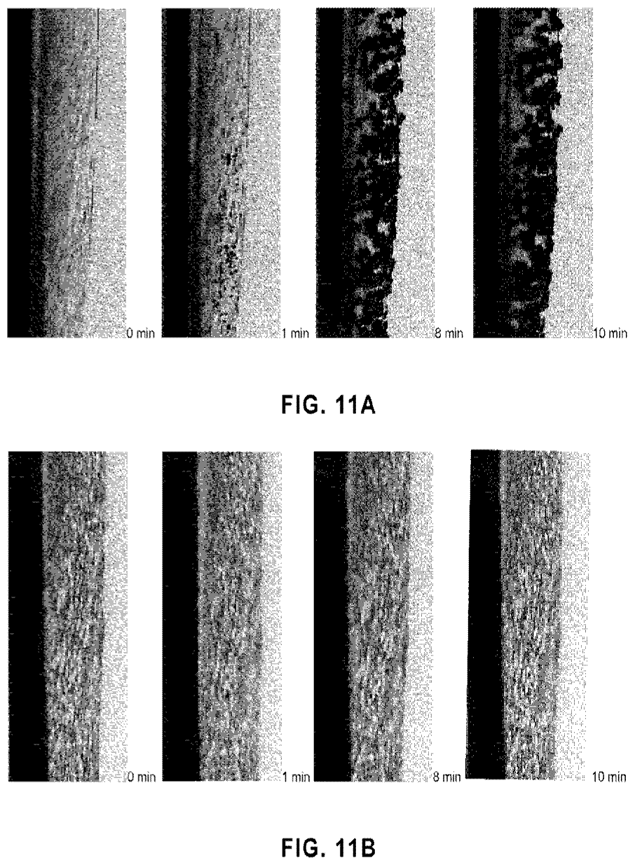

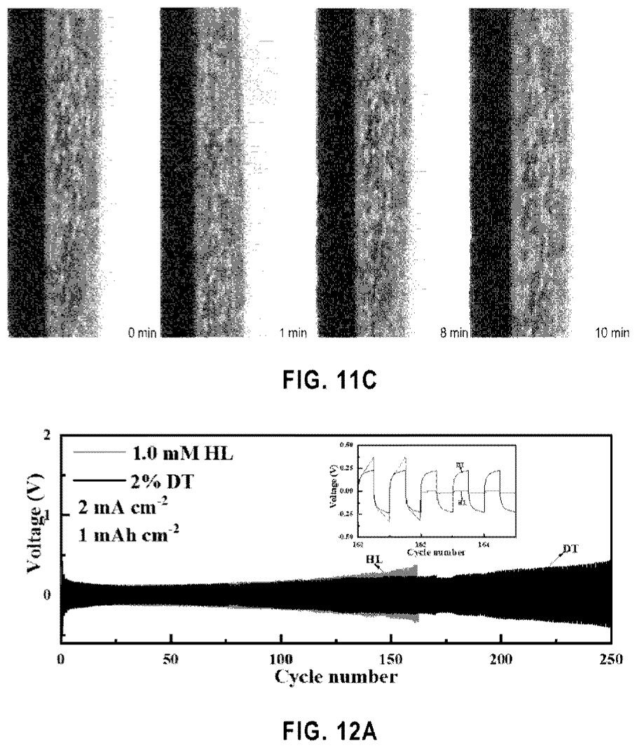

To study the behavior of Li deposition of MSAM_{HL/DT} film after serval cycles, SEM and in-situ optical measurements were conducted on samples with various electrolyte additives (FIGS. 10-11). As shown in FIG. 10a, b, pristine Li surface is very rough and lumpy, which led to the formation of cracks and many large holes after 3 cycles of Li plating in the blank electrolyte (FIG. 10c, d). Although the smoothness and uniformity of the Li surface were improved when the DT additive was added to the ester electrolyte, there were still some small cracks (FIG. 10e, f) due to the poor compactness of the SSAM_{DT} layer. Interestingly, when using the electrolyte containing DT-HL dual-additives, a dense, bright, and smooth Li plating layer formed due to the lithiophilic-lithiophobic gradient structure of the MSAM_{HL/DT} layer (FIG. 10g, h). The lithiophilic elements in the HL molecules (internal side layer of the MSAM_{HL/DT}) facilitated Li⁺ ion diffusion, while the lithiophobic carbon chain in the DT molecules (external side layer of the MSAM_{HL/DT}) regulated Li⁺ deposition and inhibited electrolyte corrosion of the Li surface.

In-situ optical microscopy was employed to investigate the Li plating dynamic behavior (FIG. 11a-c). As shown in FIG. 11a, in the blank electrolyte, protuberances were clearly observed on the Li surface after 1 min of plating, and dead Li and mossy Li formation were observed after 10 min due to the rough and uneven Li surface. In contrast, by introducing DTs into the electrolyte, DT molecules filled some of the pits on the Li surface and form an SSAM_{DT} layer, making the Li surface flat and smooth. Moreover, the lithiophobic carbon chains of the DT additive repelled Li deposits at the tip and promoted Li deposition in a flat place.²⁶ Therefore, even after 10 min, there was no obvious Li dendrite formation on the Li surface (FIG. 11b). A similar result was obtained when using the DT-HL dual-additives (FIG. 11c). No obvious dendrite growth was observed for the electrolytes containing DT or DT-HL additives during in-situ optical microscope measurements (FIG. 11b, c). The top-view SEM images show that there are more cracks on the surface treated by DT additive (FIG. 10e, f) than that treated by DT-HL additives (FIG. 10g, h), which resulted in easier Li dendrite formation on the former.

Such Li dendrite-free growth anodes with high current density in dual-additives ester electrolyte are particularly interesting for large-scale application of LMBs.

### Electrochemical Performance of Li|Li Symmetric Cells, Li|LFP and Li|NCM Full-Cells with Various Electrolytes

To verify the effect of the MSAM_{HL/DT} layer on the long-life stability and high-rate capacity of Li anodes, Li|Li symmetric cells and Li|Cu half-cells were cycled using the ester-based electrolyte containing various additives. Compared with the DT additive (250 cycles), the ester electrolyte with HL additives delivered a poor cycle performance (162 cycles) at a current density of 2 mAh cm⁻² with a capacity of 1 mAh cm⁻² (FIG. 12a). This is because the aromatic nucleus of HL molecules possesses high steric hindrance, resulting in a loose and semi-bright SSAM_{HL} layer that promoted the formation of Li dendrites. However, when DT-HL dual-additives were used, the electrochemical performance of the assembled symmetric cell was superior to that of blank electrolyte and electrolytes with DT or HL additives. As shown in FIG. 12b-c, the battery with DT-HL dual-additives can be cycled stably up to 600 cycles at 1 mA cm⁻²/0.5 mAh cm⁻² and 150 cycles at 6 mA cm⁻²/1.0 mAh cm⁻². Under the same test parameters, the Li|Li symmetric cells with DT additive and blank electrolyte displayed much poorer cycle performances of 340 cycles and 200 cycles at 1 mA cm⁻² and 75 cycles and 25 cycles at 6 mA cm⁻², respectively.

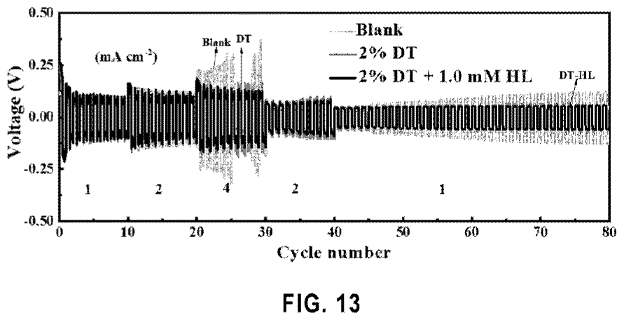

To evaluate the stability of Li anode at high-rate current density, assembled symmetric Li|Li cells were analyzed at current densities of 1.0 mA cm⁻², 2.0 mA cm⁻² and 4.0 mA cm⁻² with capacity of 0.5 mAh cm⁻², 1.0 mAh cm⁻² and 2.0 mAh cm⁻², respectively (FIG. 13). In the blank electrolyte, a short circuit phenomenon was observed after 26 cycles. By contrast, the symmetric cell with DT and DT-HL additives delivered a stable voltage hysteresis. When using the DT-HL dual-additives, a higher initial voltage hysteresis was observed, demonstrating a large amount of Li uniform nucleation to form the MSAM_{HL/DT} film.

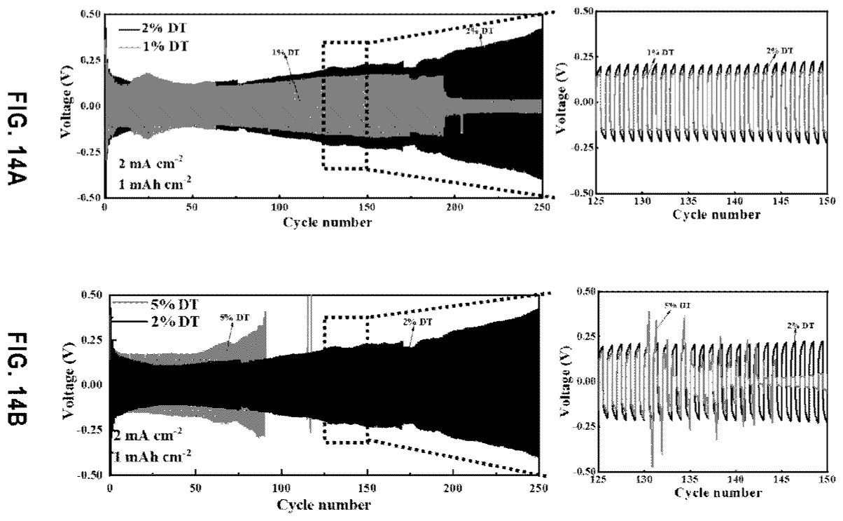

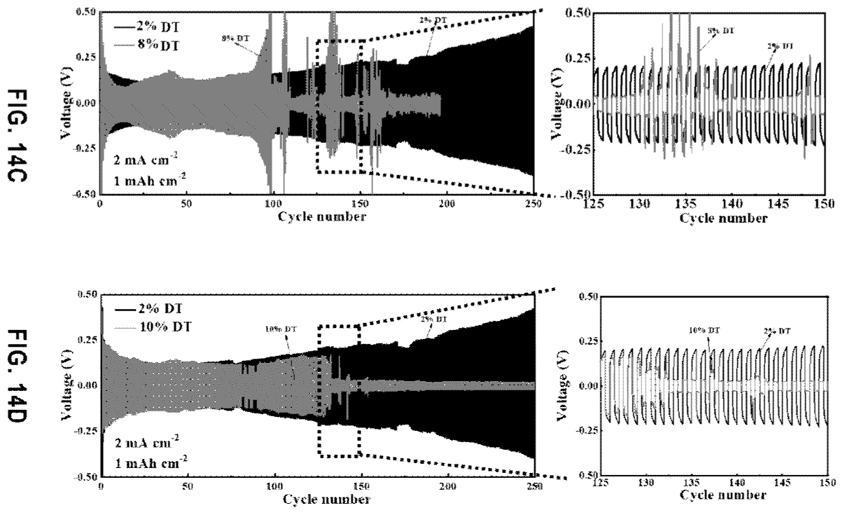

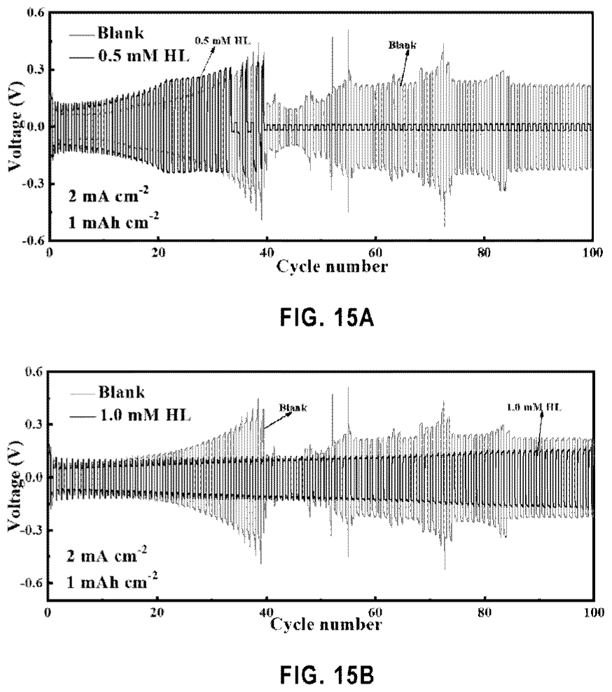

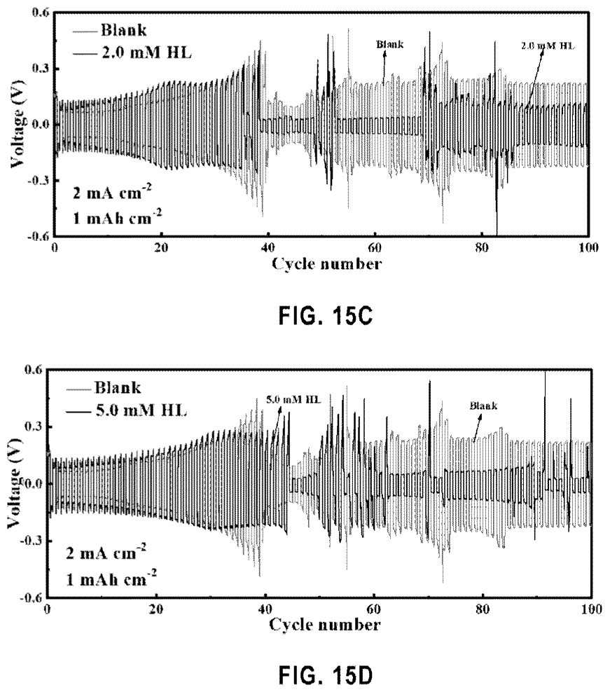

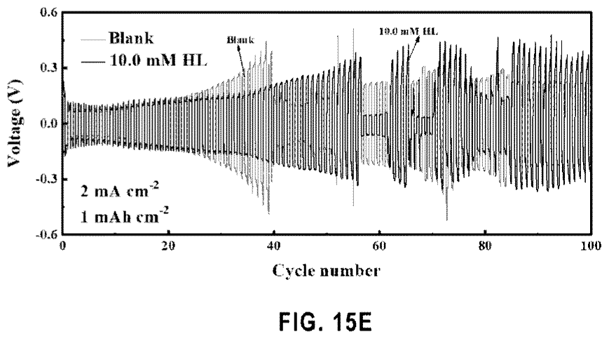

FIG. 14a-d and FIG. 15a-e verify the effect of the DT and HL concentrations on the performance of Li|Li symmetric cells. It is clear that cells using 2% DT or 1.0 mM HL additives exhibited much higher cycling stability than those containing other concentrations of these additives (DT: 1%, 5%, 8%, 10% or HL: 0.5 mM, 2.0 mM, 5.0 mM, 10.0 mM).

Additionally, to clarify the effect of the length of carbon chain on the cycling performance of Li|Li symmetric batteries, battery cells with DT-HL, DT-1-hexadecanethiol (HT) and DT-1-Octadecanethiol dual-additives were studied (FIG. 16). 1-Octadecanethiol was insoluble in carbonate solvent. As shown in FIG. 16, the DT-HL dual-additive shows good cyclic stability. This is because too long a carbon chain disorderly accumulates on the Li surface and promotes the formation of Li dendrites.

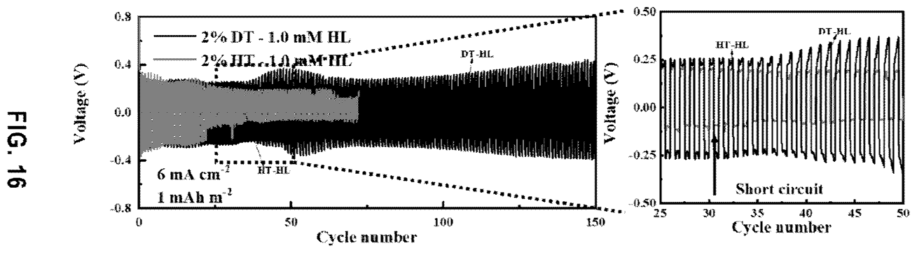

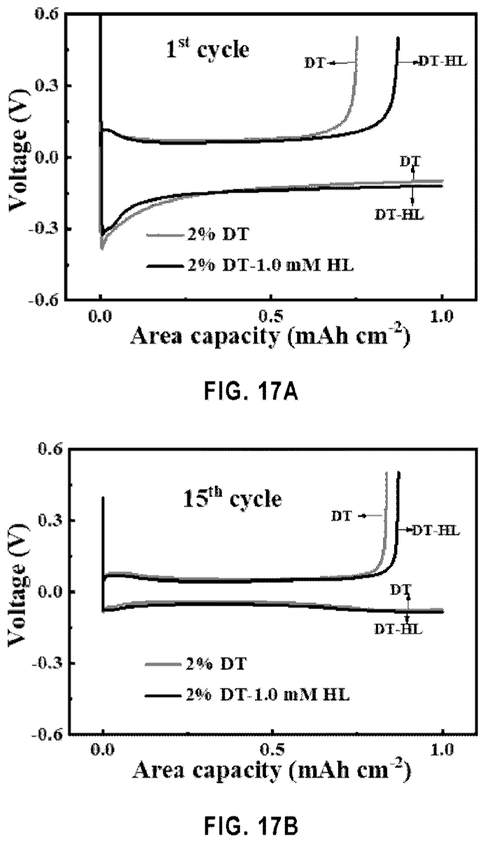

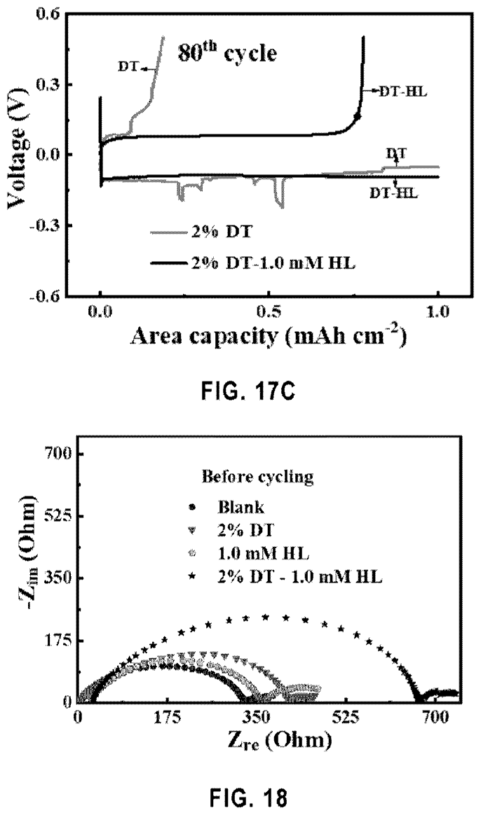

The CE performance is another standard for evaluating the performance of Li anode. The CE performance of Li|Cu cells with different electrolyte systems was conducted, as shown in FIG. 17a-c. A short circuit phenomenon was observed after 80 cycles for cell with the DT additive, which indicated that dead and mossy Li have appeared.²⁷ By contrast, when the ester electrolyte containing DT-HL dual-additives was used, the Li|Cu cell exhibited a stable voltage curve, which demonstrated the excellent coulombic efficiency even after 80 cycles at 1 mA cm⁻²/1 mAh cm⁻².

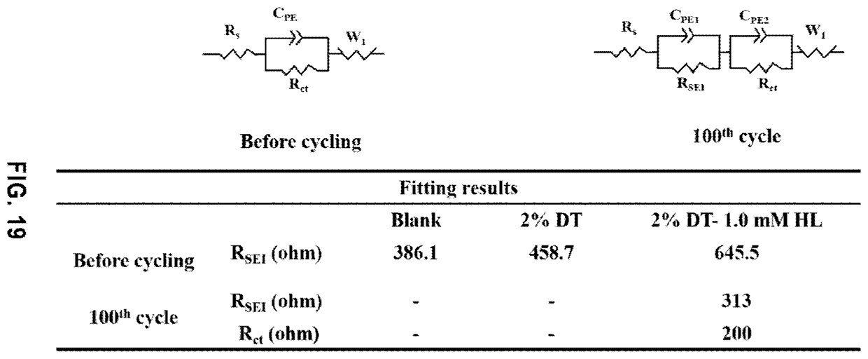

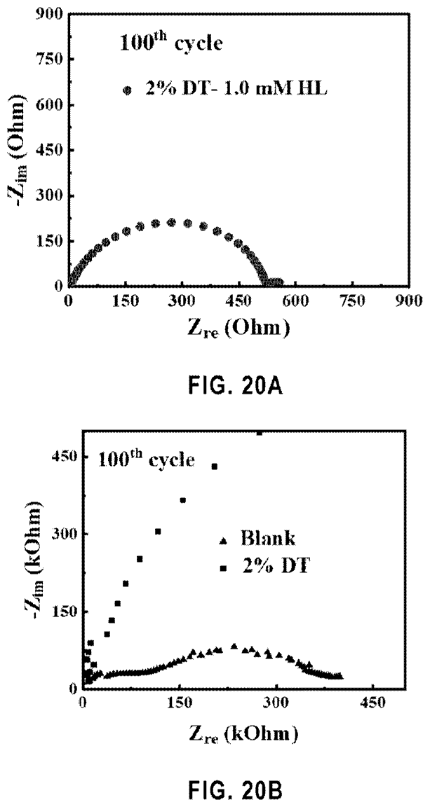

Finally, the electrochemical impedance spectroscopy (EIS) spectra of Li|Li symmetric cells were recorded to verify the efficacy of various additives at a current density of 6 mA cm⁻² before and after 100^{th} cycles (FIG. 18, FIG. 19, FIG. 20 and Table 1). Before cycling, as shown in FIG. 18, the cell with DT-HL dual-additives displays the highest charge transfer resistance (R_{ct}) of 386.1 Ω compared with unmodified electrolyte and with the DT additive (FIG. 19). The highest R_{ct} was mainly because of the dielectric resistance of the carbon chain and the large steric hindrance of the aromatic nucleus of HL molecules. After the 100^{th} cycle (FIG. 20a, b), the EIS spectra of the Li|Li cells with the blank electrolyte and the electrolyte with DT additive showed some messy points, which demonstrated the accumulation of mossy Li. However, for the cell using the DT-HL dual-additive, the R_{ct} and R_{SEI} decreased after 100 cycles due to the dense and stable MSAM_{HL/DT} film, which inhibited side reactions and decomposition of the electrolyte, thus reducing the interface resistance.²⁸

TABLE 1
The equivalent circuits of the electrochemical
impedance spectroscopy and fitting results
Fitting results

| | | 2% DT - 1.0 mM HL |
|---|---|---|
| 100^{th} cycle | R_{SEI} (ohm) | 313 |
| | R_{ct} (ohm) | 200 |

### The Step-by-Step Modulation Mechanism of DT-HL Dual-Additives on Li Anode

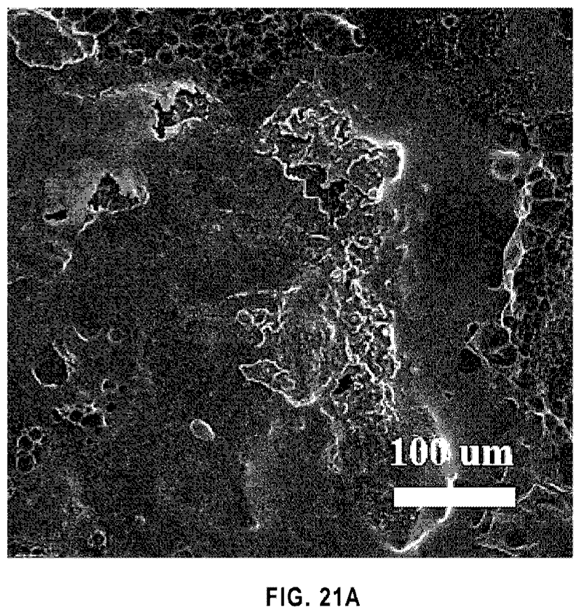

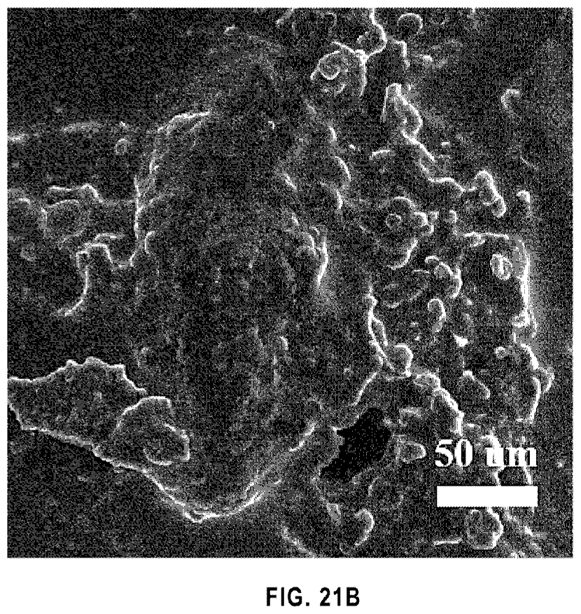

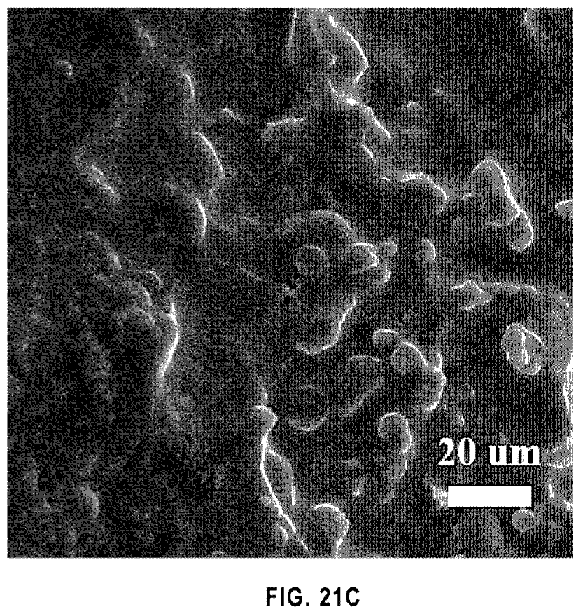

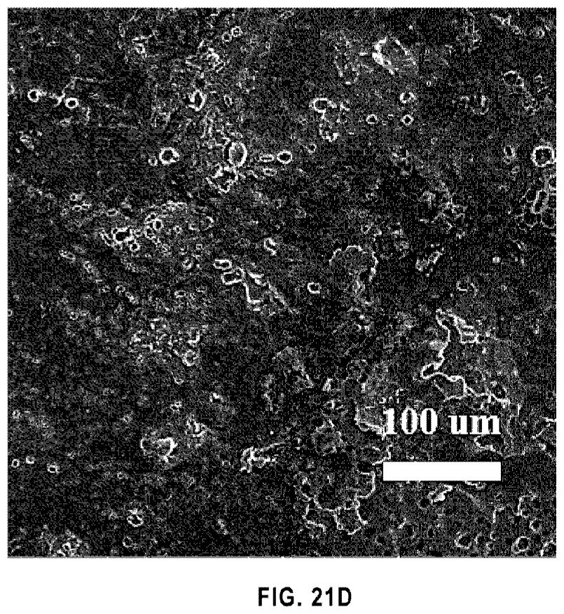

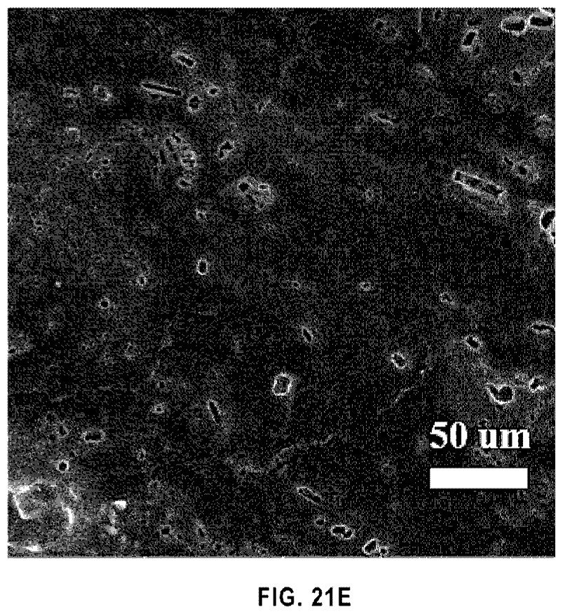

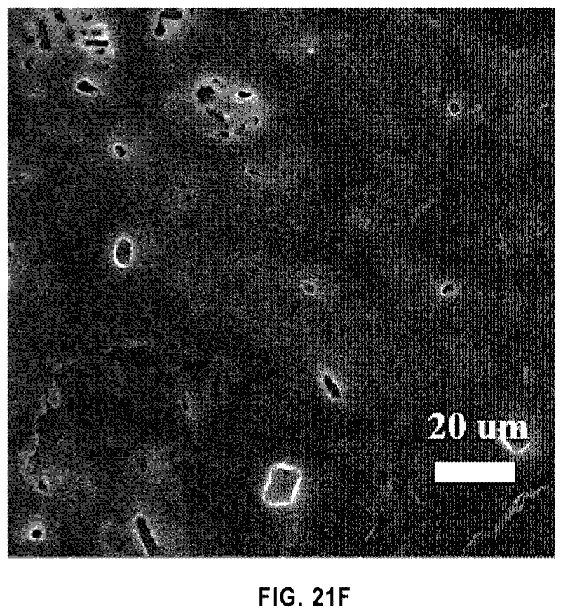

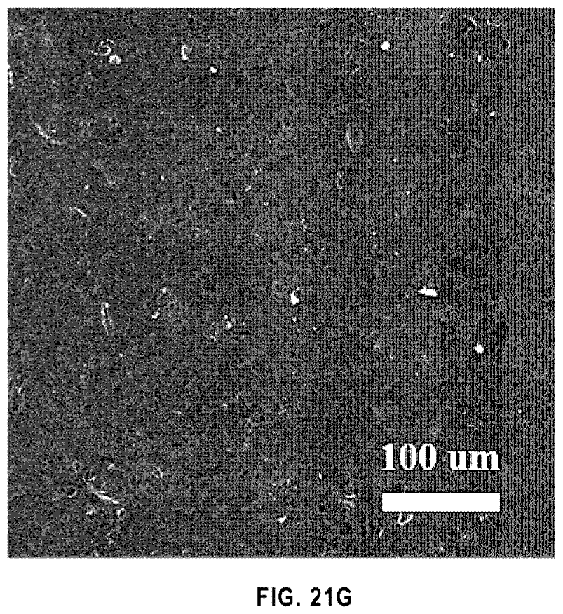

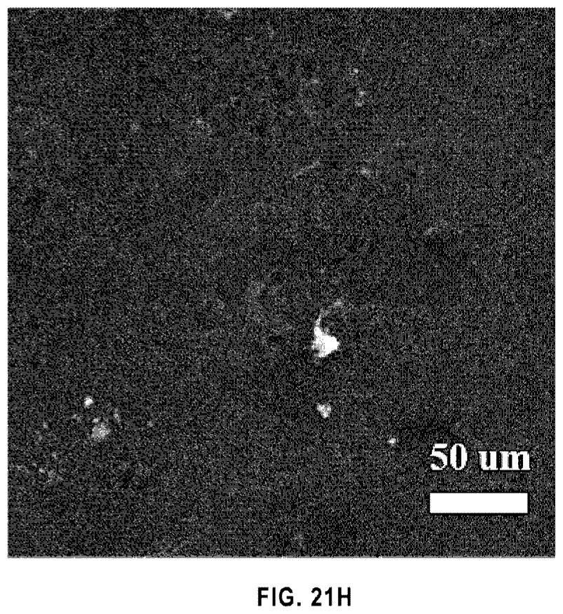

The morphology of the Li anode was analyzed after 100 cycles (FIG. 21). In the blank electrolyte, some cracks, dead Li patches and mossy Li were observed (FIG. 21a-c). Although the lithium surface became relatively flat when introducing the DT additive into the ester electrolyte, the lack of Li⁺ ion inducer made the lithium surface rough again, therefore mossy lithium dendrites and some small holes were clearly observed (FIG. 21d-f). However, as shown in FIG. 21g-i, when DT-HL dual-additives were used, metallic Li was stripped uniformly on Li surface with MSAM_{HL/DT} film and the formation of dead Li and massive dendrites was reduced.

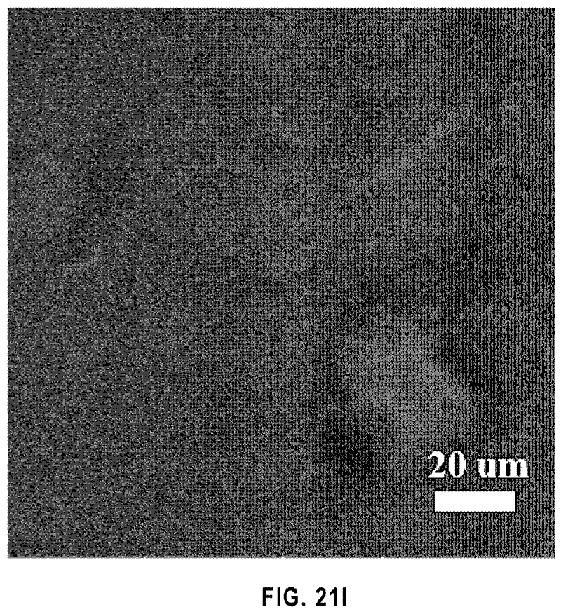

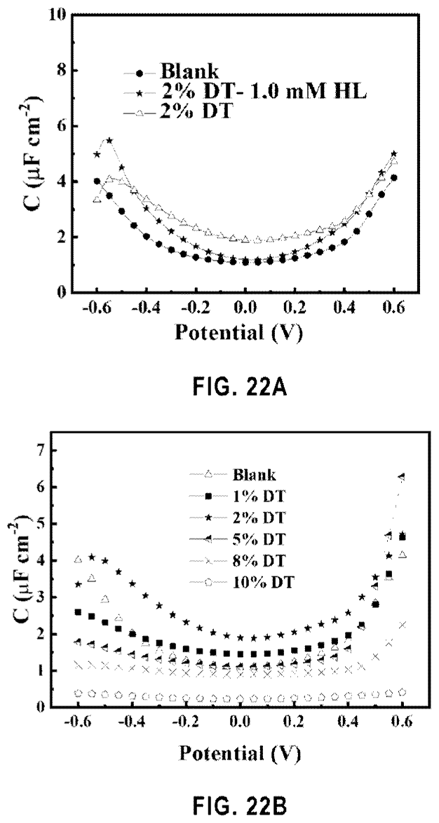

To study the self-assembly progress of DT-HL dual-additives, differential capacitance measurements with the various electrolytes and density functional theory (DFT) calculations were made. First, as shown in FIG. 22a, when using the ester electrolyte with DT and DT-HL dual-additives, capacitance peaks were observed at −0.54 V and −0.55V, respectively. The minimum capacitance on the surface represents the position of the potential of zero charge (PZC).²⁹ When the additives were added into the electrolyte, the value of PZC slightly shifted from 0.01 V to 0.03V, which indicated that the additives (DT or DT-HL) were absorbed on the Li surface. Moreover, the capacitance of ester electrolyte containing DT and DT-HL additives was higher than that of the blank electrolyte, indicating that the additives regulated the Helmholtz plane and improved the layer contact with the Li anode.³⁰ As shown in FIG. 22b, to change the concentration of DT additive, the electrolyte with 2% DT additive exhibited the highest capacitance results in the excellent contact with Li anode.

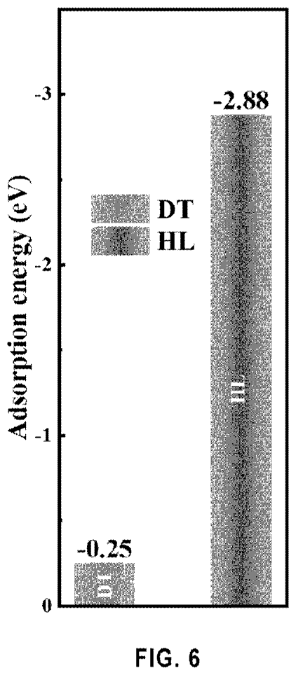

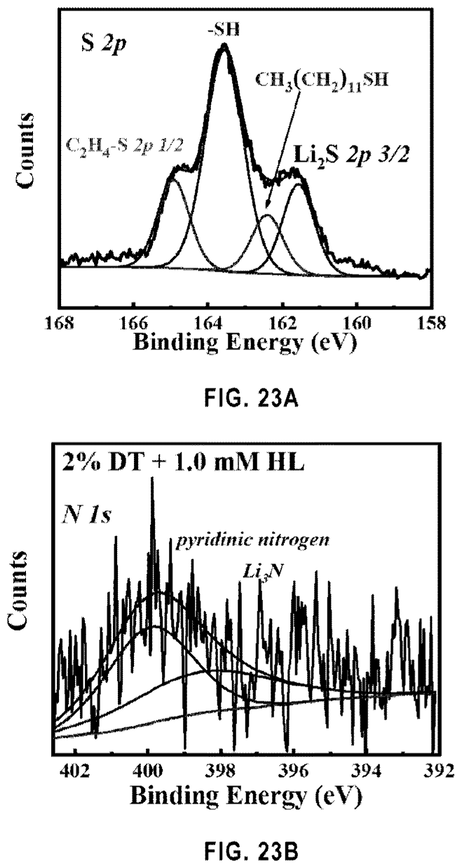

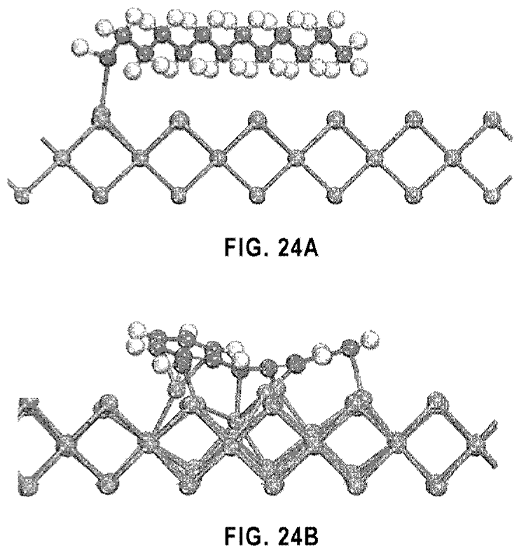

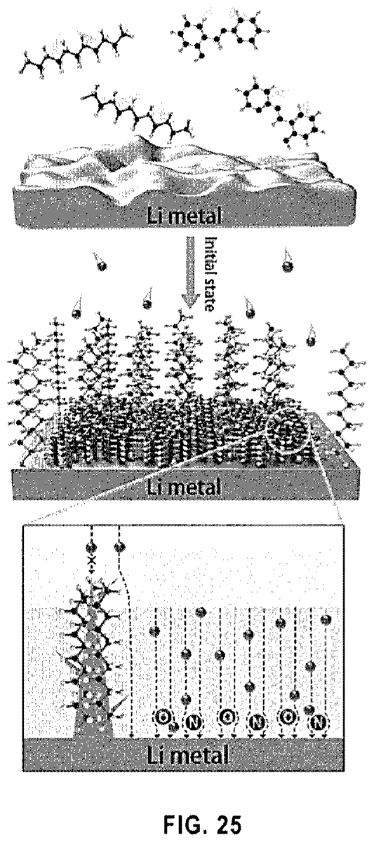

In S2p and N1s (FIG. 23a-b) XPS spectra of the surface of the Li anode treated with an electrolyte containing 2% DT-1.0 mM HL additives, Li—S bond, pyridinic nitrogen and Li₃N characteristic peaks were observed at 161.9 eV, 399.7 eV and 398.5 eV, respectively. These were assigned to the functional groups of DT and HL molecules. These results verify that the DT and HL additives self-assembled on Li surface via their functional groups. Finally, as can be seen from FIG. 24a, b and FIG. 6, the HL molecules preferentially adsorb on the rough Li surface due to the lower adsorption energy (−2.88 eV) compared with DT (−0.25 eV) and then DT molecules fill the pits and the gap between the HL molecules to form a dense and stable MSAM_{HL/DT} film (FIG. 25).

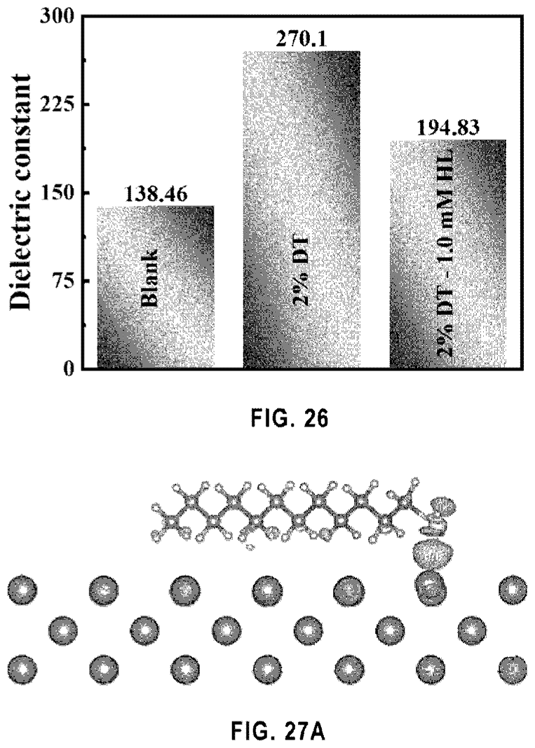

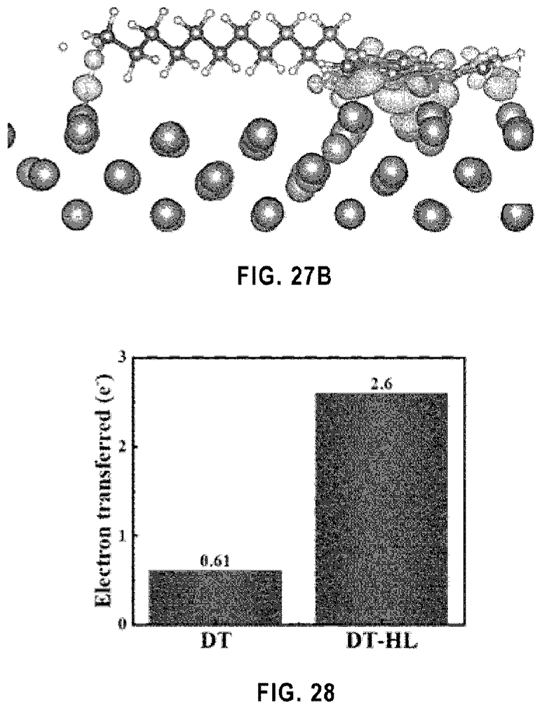

To investigate the effect of electric field mediated of MSAM_{HL/DT} film on Li deposition, the dielectric constant and charge density difference with different electrolytes were measured (FIG. 26 and FIG. 27a,b). The high dielectric constant contributes to the decreased electric field intensity involved in lithium plating, thus suppressing dendritic lithium growth.^{31,32} As exhibited in FIG. 26, the dielectric constant values of DT additive and DT-HL dual-additives were higher than that of untreated ester electrolyte, due to the dielectric resistance of lithiophobic carbon chain.³¹ Although the ester electrolyte with the DT additive displayed a higher dielectric constant value than that with DT-HL dual-additives, its cyclic stability was much poorer. This is because compared with the DT additive, the MSAM_{HL/DT} film formed with DT-HL dual-additives has a core-shell structure, with a lithiophobic carbon chain as the shell and lithophilic HL molecules as the core. During the Li deposition progress, the shell of the MSAM_{HL/DT} film flattened the Li anode surface, repelling Li⁺ ions and reducing the space charge effect. The core of the MSAM_{HL/DT} film not only regulated the deposition of repelled Li⁺ ions, but also further promoted Li uniform nucleation to form a dense and stable MSAM_{HL/DT} film (FIG. 25). FIG. 27a, b and FIG. 28 show the charge density difference of DT additive and DT-HL dual-additives. When DT molecules adsorb on the Li surface, a 0.61 e⁻ charge is transferred from the Li metal to the DT molecule. When DT-HL molecules adsorb on the Li surface, 2.60 e⁻ is transferred from the Li slab to the adsorbate. Therefore, compared with the DT additive, Li⁺ ions in the ester electrolyte containing DT-HL dual-additives obtained electrons more easily from the Li surface and reduced them more quickly. Therefore, the electrolyte with the DT-HL dual-additives exhibited excellent regulation and inducibility for Li deposition and uniform nucleation. Meanwhile, the higher charge transfer number also attracted more Li⁺ ions from the bulk solution and promoted Li diffusion.³³

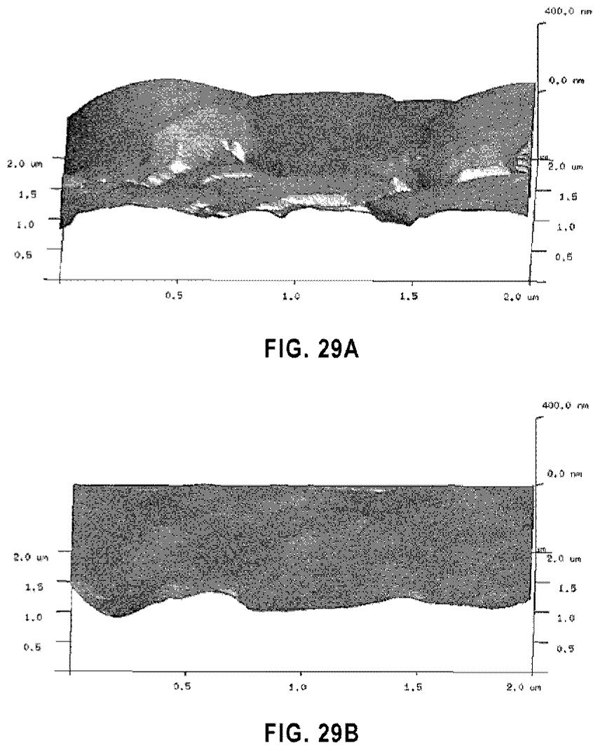

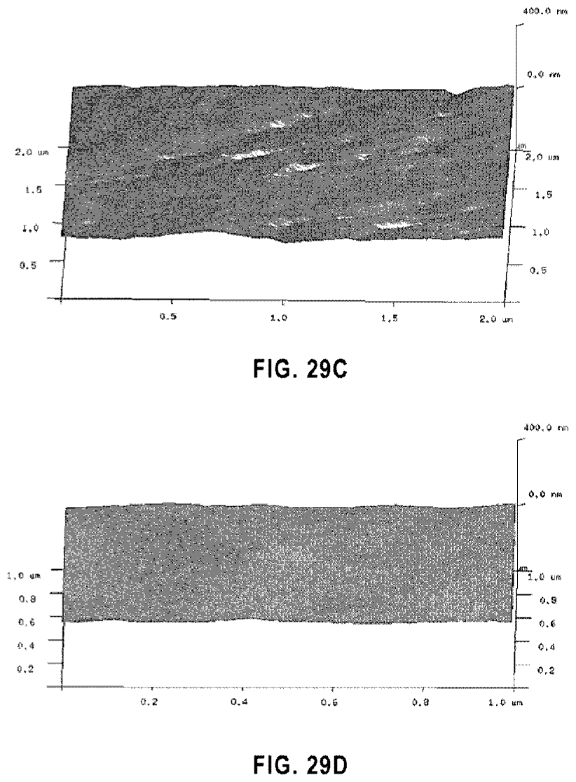

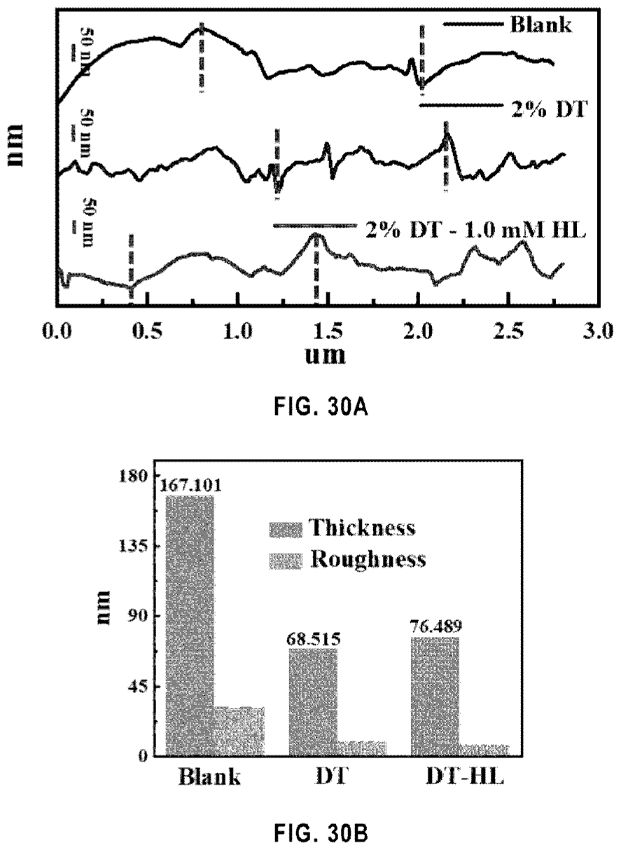

Atomic force microscopy (AFM) was used to further study the flatness of the film formed on the copper surfaces with different ester electrolytes, as displayed in FIG. 29. With the blank electrolyte, the surface is very rough and uneven and the value of flatness is 31.7 nm (FIGS. 29a and 30), which is consistent with the SEM observations shown in FIG. 10c, d. Compared to the DT additive (9.11 nm, FIGS. 29b and 30), the morphology of DT-HL dual-additives on copper had a smooth, flat, and uniform deposition (6.99 nm, FIGS. 29c-d and 30), forming a dense and stable MSAM_{HL/DT} film. Moreover, the DT-HL dual-additive film (76.489 nm) was thicker than the DT additive (68.515 nm), which inhibited Li dendrites growth and decomposition of the electrolyte. However, the thickness of the blank electrolyte film was the highest (167.101 nm) due to the uneven surface.

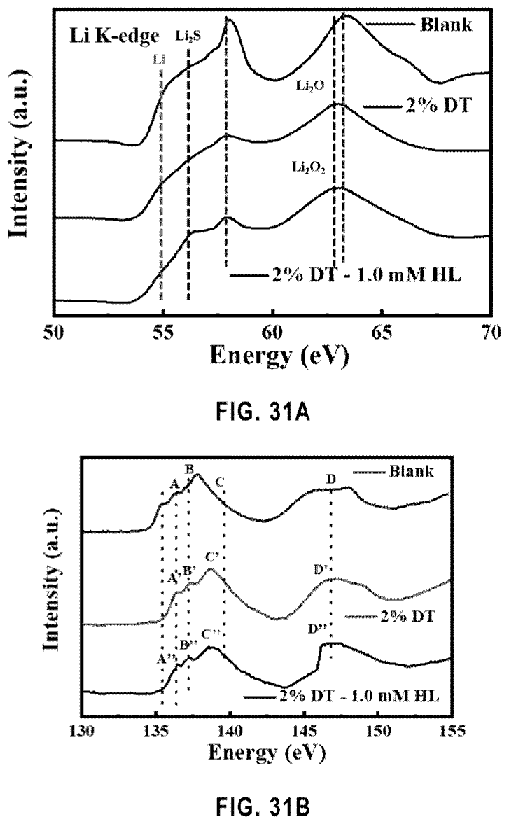

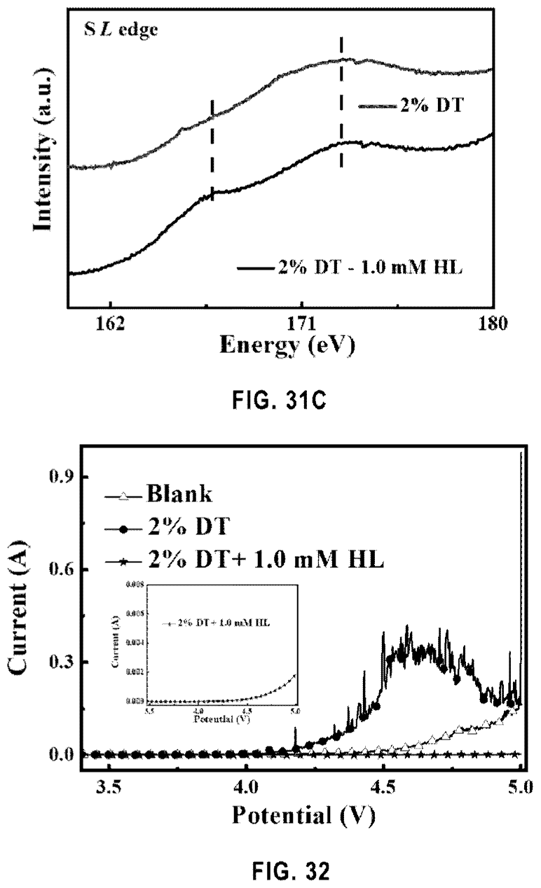

Additionally, according to equation 1³⁴, where i represents the nucleation speed of Li, A and B are constant, V represents the overpotential. As the highest overpotential of the DT-HL dual-additives in comparison to the blank electrolyte and the DT additive (FIG. 12b-c and 13), the formation rate of new crystal nuclei will increase rapidly, and the crystal grains of the Li plating layer will become finer, thus forming an MSAM_{HL/DT} film.³⁵ To further illustrate the effect of MSAM_{HL/DT} film on Li uniform nucleation, the Li K-edge, phosphorous (P) L-edge and sulfur (S) L-edge X-ray absorption near edge structure (XANES) were measured to prove the lithiated products, which are presented in FIG. 31.

$$ln i = A - \frac{B}{V} \qquad ( 1 )$$

As shown in the fluorescence yield (FLY) spectrum (FIG. 31a), no resonance of Li metal was observed at ˜55 eV, which indicates that a passivation film is formed on the Li anode surface. A resonance at ˜56.7 eV may be attributed to Li₂S in DT-HL dual-additives. Moreover, Li₂O was observed at 58.1 eV and 63.8 eV, respectively. However, in DT and DT-HL dual-additive electrolyte systems, the peak position shifted from 63.8 eV negative to 62.9 eV, which means that new material had formed (Li₂O₂). FIG. 31b shows the P L-edge XANES spectra, which were used to demonstrate the intimate interaction and surface chemistry modification in different electrolyte systems. The peaks A, B and C are attributed to the LiaP₂O₇. The highest edge transitions at peaks D, D′ and D″ are attributed to the 2p to 3d transitions (due to multiple scattering). However, when introducing DT and DT-HL additives into the electrolyte system, the positions of peaks A, B and C have changed where a positive energy shift in the DT and DT-HL system, which formed a new material of Li₃PO₄. FIG. 31c shows the S L-edge XANES spectra of SEI films generated from combining DT with HL. The peak at 166.78 eV was attributed to C—S σ* excitations, which indicated that the DT was absorbed on the Li surface. The peak of 173.01 eV was attributed to Li—S—Li. Therefore, the lithiation products (Li₂S, Li₂O₂, Li₃PO₄, Li₃N) of modified ester electrolyte inhibited the formation of Li dendrite growth sites and also increased the number of Li nucleation sites, so a dense and stable MSAM_{HL/DT} film was obtained.

To clarify the stability and composition of MSAM_{HL/DT} film in DT-HL dual-additives electrolyte, linear sweep voltammetry (LSV) measurements, Zeta potential experiments and XPS measurements were carried out. As shown in FIG. 32, the current started at 4.2 V for the ester electrolyte with DT additive and 4.6 V for the untreated ester electrolyte. By contrast, the addition of DT-HL dual-additives ester electrolyte showed a negligible current (<2 mA). This result demonstrates the outstanding stability of DT-HL to produce a stable MSAM_{HL/DT} film during the electrochemical cycles.

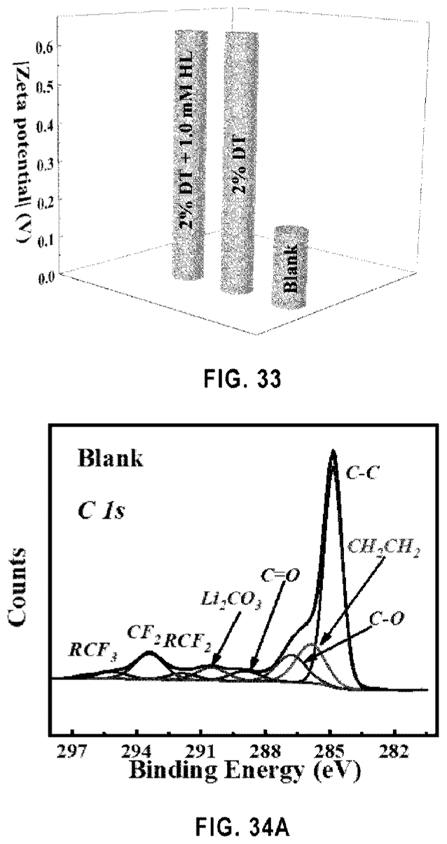

Moreover, the DT-HL exhibited a higher Zeta potential than blank ester electrolyte (FIG. 33), facilitating a more stable MSAM_{HL/DT} film³⁶, which is consistent with the results of FIG. 32.

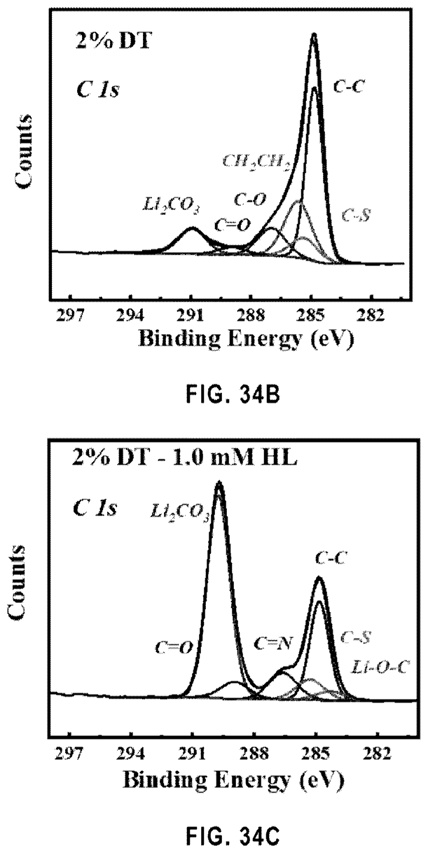

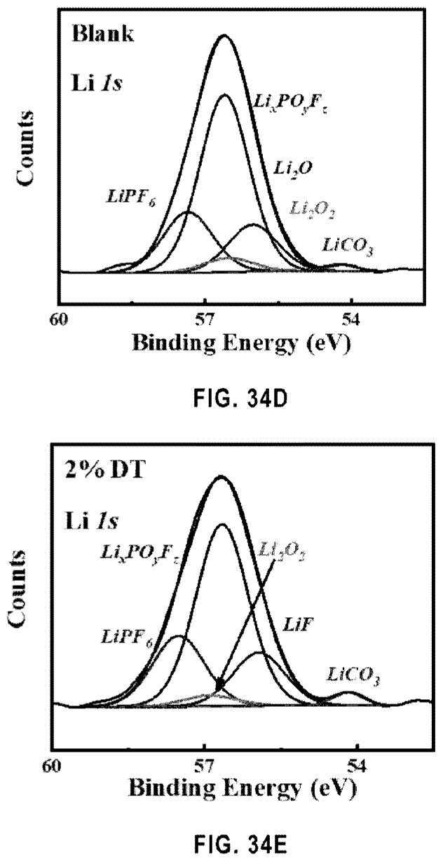

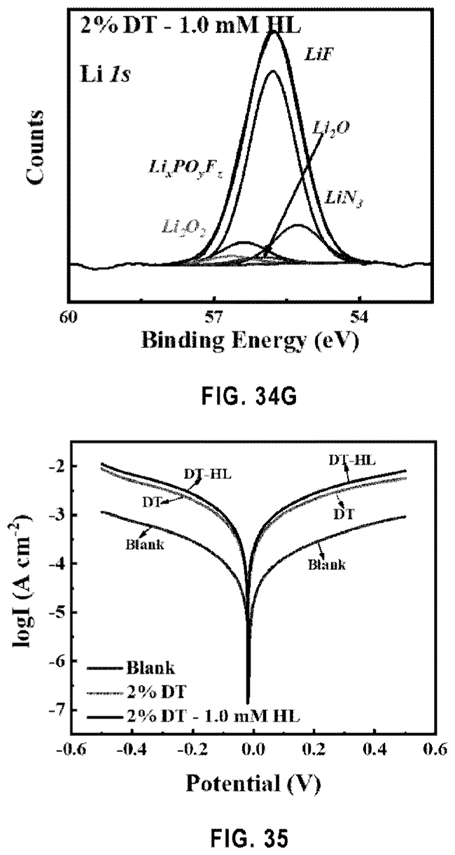

To confirm that the DT-HL dual-additives were indeed involved in the MSAM_{HL/DT} film formation, C 1s and Li 1s spectra of reacted Li anode at a current density of 0.5 mA cm⁻² after 3 cycles in blank or treated electrolytes were acquired (FIG. 34). FIG. 34a-c shows the C 1s XPS spectra. The peak located at 286.49 eV, 285.3 eV and 284.28 eV correspond to the characteristic peaks C═N, Li—O—C of the HL molecule and C—S of the DT molecule, respectively³⁷. In the Li 1s spectra (FIG. 34d-f), the peak at 55.8 eV was attributed to LiF due to the presence of sulfhydryl (—SH) and C—OH.^{38,39} This is because the large 3s/3p hybrid orbital of S forms a bond with the smaller 1s hybrid orbital of hydrogen, which causes the weaker S—H bond to release H⁺ ions, thereby forming LiF. Similarly, when HL molecules are added to the electrolyte, the weak C—O—H bond will also release H⁺ ions, which explains why the intensity of LiF in FIG. 34f is greater than that in FIG. 34e. Moreover, in the N XPS spectrum, the peak of Li₃N was observed,²⁴ which demonstrated the DT-HL dual-additives can regulate lithium-ion deposition very well.

In summary, based on the analysis of the above XPS results, the DT-HL dual-additives produced a stable MSAM_{HL/DT} film that suppressed Li dendrites formation.

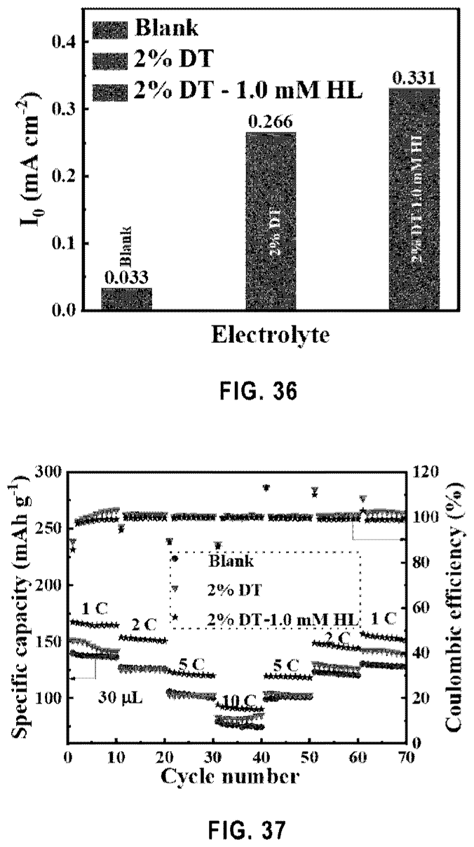

To study the charge transfer kinetics of anode-electrolyte interface, the exchange current density (I₀) for Li symmetric cell was measured from Tafel plots (FIGS. 35 and 36) at a current density of 6 mA cm⁻² after 10 cycles. Higher I₀ illustrates a better charge transfer capability across a smooth and flat Li plating layer.⁴⁰ As shown, DT-HL delivered the highest I₀ values.

### Electrochemical Performance of Li|LifePO₄ and Li|LiNi_{0.8}Co_{0.1}Mn_{0.1} Full Device

The cyclic performance of Li|LiFePO₄ (LFP) and Li|LiNi_{0.8}Co_{0.1}Mn_{0.1} (NCM) full devices were measured to evaluate the potential application of DT-HL dual additives in commercial batteries. The rate performance of Li|LFP devices assembled with untreated and DT-HL dual-additives or DT single additive is presented in FIG. 37. At 10 C, the device with DT-HL dual-additives delivered a higher specific capacity of 90.3 mAh g⁻¹ than that with the blank electrolyte (75.4 mAh g⁻¹). When the current density decreased from 10 C to 1 C, the device with DT-HL dual-additives achieved a specific capacity of 146.3 mAh g⁻¹.

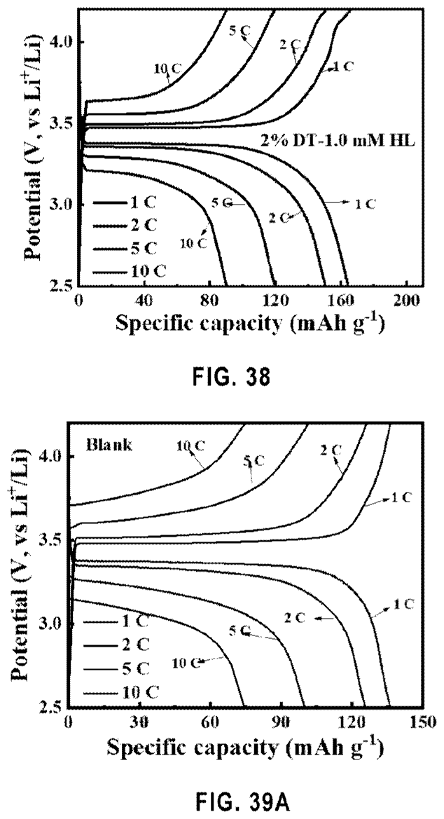

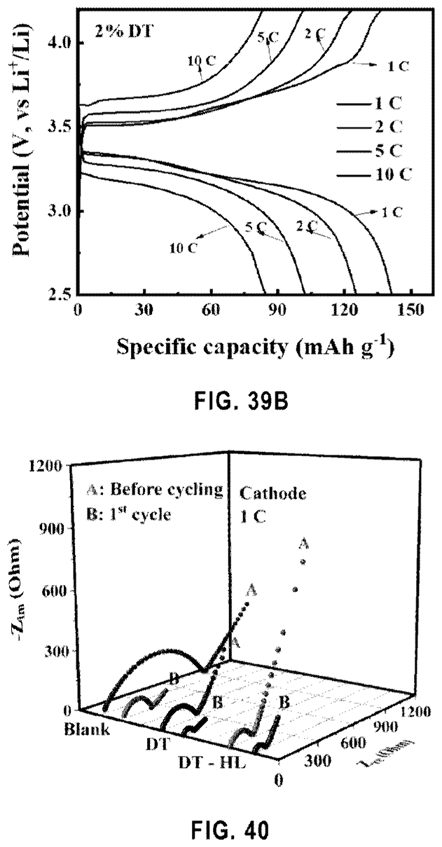

FIG. 38 and FIG. 39a-b show the charge-discharge curves at different current densities in various ester electrolyte systems. The LFP cathode had a lower potential gap in dual-additive electrolyte than in the blank or DT additive electrolyte at a current density of 10 C.

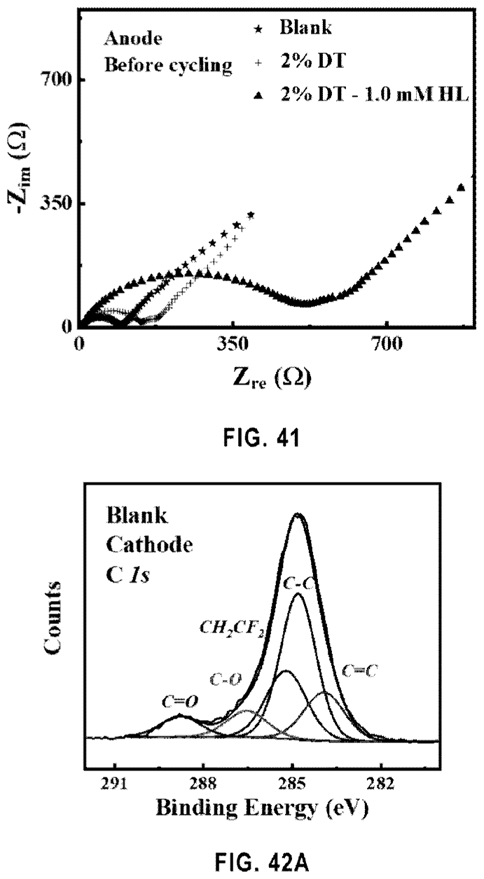

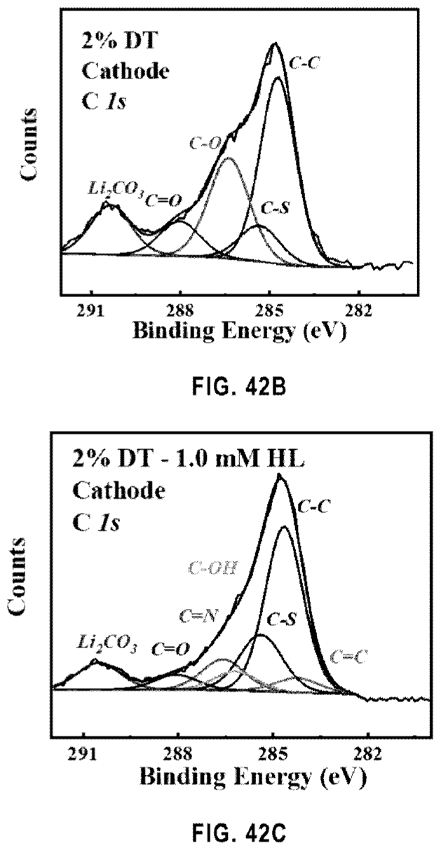

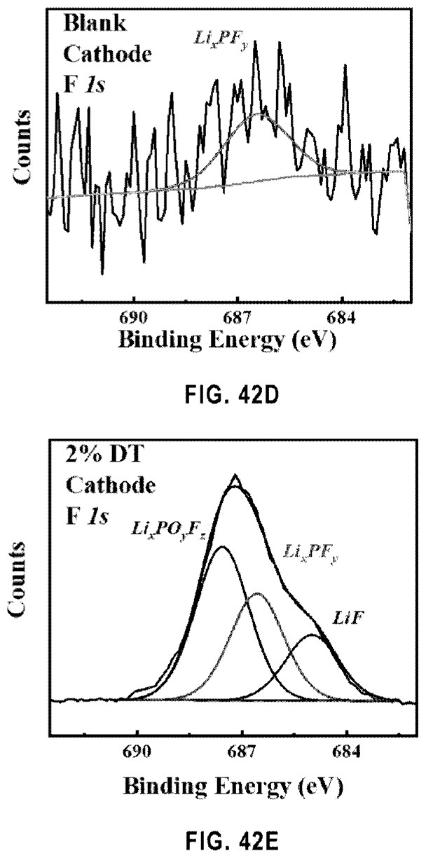

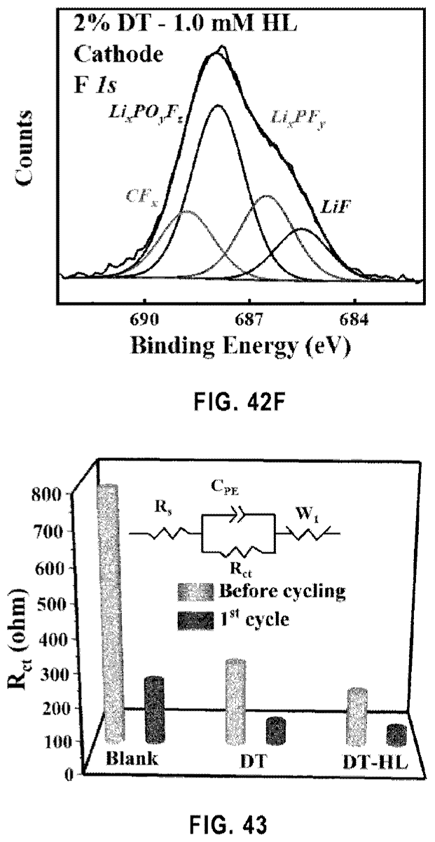

To evaluate the high specific capacity of DT-HL dual-additive at the lowest current density of 1 C, EIS experiments and XPS analysis were carried out (FIG. 40, FIG. 41, and FIG. 42). As presented in FIG. 41, EIS analysis was conducted on Li anode of Li|LiFePO₄ full cell in different electrolytes before cycling. The battery with DT-HL dual-additives delivered the smallest R_{ct} value compared to the other electrolytes, which indicated an MSAM_{HL/DT} film formed on the Li anode and promoted the utilization of Li. This is consistent with the results shown in FIG. 18.

TABLE
Fitting results corresponding to FIG. 41
Fitting results

| | | Blank | 2% DT | 2% DT- 1.0 mM HL |
|---|---|---|---|---|
| Before cycling | R_{ct} (ohm) | 86.63 | 141.2 | 472.9 |

FIGS. 40 and 43 show the EIS and fitting results of the LifePO₄ cathode before and after cycling. The introduction of DT-HL dual-additive illustrated the lowest R_{ct} value. The EIS results combined with the positive and negative electrodes show that the DT-HL not only stabilized the lithium negative electrode but also reduced the decomposition of the electrolyte, but also promoted the transport of Li ions, thereby achieving high specific capacity at low current densities.

To further investigate why DT-HL obtained high specific capacity, XPS characterization of the LifePO₄ cathode at 1 C after 10 cycles was carried out (FIG. 42a-f). In the C 1s spectra, the C—S, C—OH and C═N bonds are observed, which may be attributed to the characteristic peaks of DT and HL, respectively. In the F 1s spectra of the device with the DT-HL dual additive, the CFₓ group was observed. The CFₓ species promotes a better Li diffusion during cell operation. Therefore, the cell with a DT-HL dual additive displayed a higher specific capacity after 10 cycles.

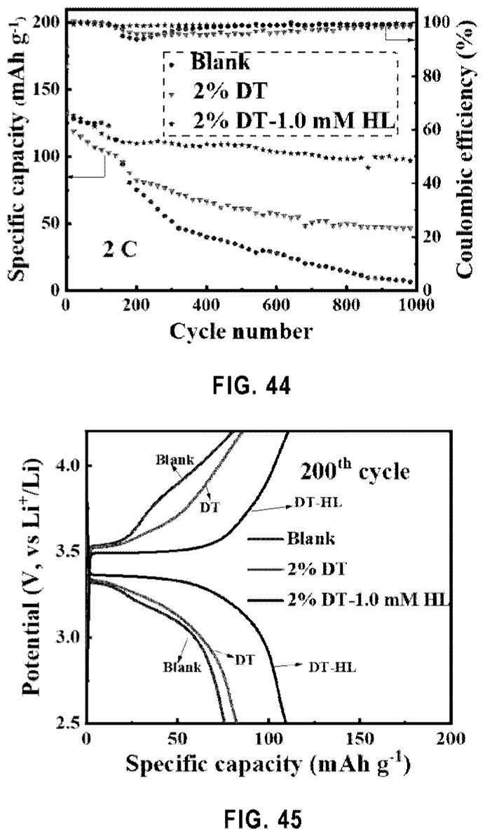

As can be seen from FIG. 44, the Li|LFP device with DT-HL dual-additive had an excellent cycling stability with a high reversible capacity of 98.5 mAh g⁻¹ after the 800^{th} cycle at a current density of 2 C. By comparison, the devices with blank and single additive electrolyte exhibited lower specific capacities of 13.9 mAh g⁻¹ and 49.8 mAh g⁻¹, respectively.

As shown in the charge-discharge curves shown in FIG. 45, the device with DT-HL dual-additives exhibited a lower potential gap (130 mV) than the device with the blank electrolyte (229 mV).

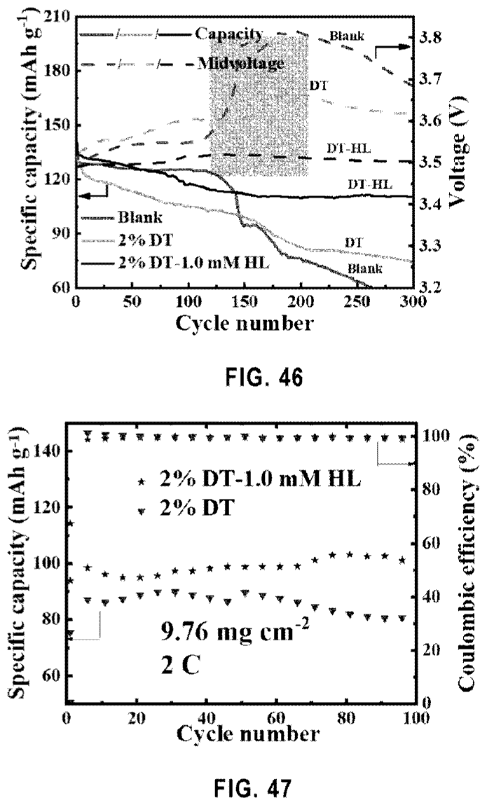

FIG. 46 shows the discharge capacity and mid-voltage plotted as a function of the cycle number. This illustrated the effect of DT-HL dual-additives in the full cell. The specific capacity of the cell exhibited a downward trend from 115 to 200 cycles and from 150 to 200 cycles in the blank and DT additive electrolytes, respectively. By comparison, the mid-voltage showed an almost inverse relationship, which illustrated a sharp increase in voltage. The strong inverse relationship between medium voltage and capacity indicated that the evolution of dead and mossy lithium directly affected the performance and failure of the full battery.⁴¹ For the device with the DT-HL dual-additives, the specific capacity and mid-voltage curves were almost straight lines, showing that the DT-HL additives formed a stable MSAM_{HL/DT} film that promoted Li transport and inhibited the formation of Li dendrites. Moreover, even under lean electrolyte condition), the full cell with DT-HL delivered a reversible capacity (FIG. 47) of 98.64 mAh g⁻¹ at 2 C after 100 cycles, which was higher than that for the DT additive (i.e., 76.49 mAh g⁻¹). This result indicated that the MSAM_{HL/DT} film prepared by self-assembly had good contact and wettability with Li anode and electrolyte.

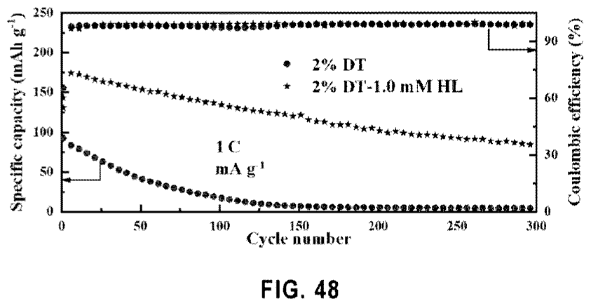

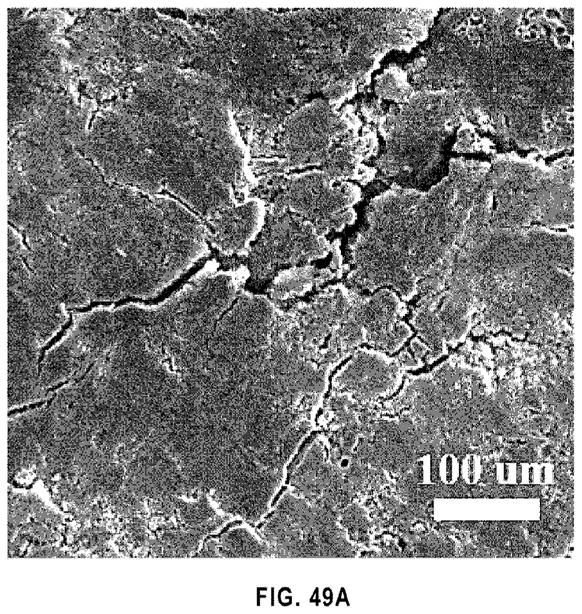

A high voltage Li|LiNi_{0.8}Co_{0.1}Mn_{0.1}O₂ full cell was assembled to confirm the stability of the ester electrolyte with DT-HL dual-additives (FIG. 48). The battery device with DT-HL dual-additives achieved a higher cyclic stability at 1 C than that with the DT additive. The device with the DT additive showed poor cyclic stability after 50 cycles. By contrast, the device with DT-HL dual-additives displayed an excellent reversible capacity of approximately 84.19 mAh g⁻¹ after 300 cycles.

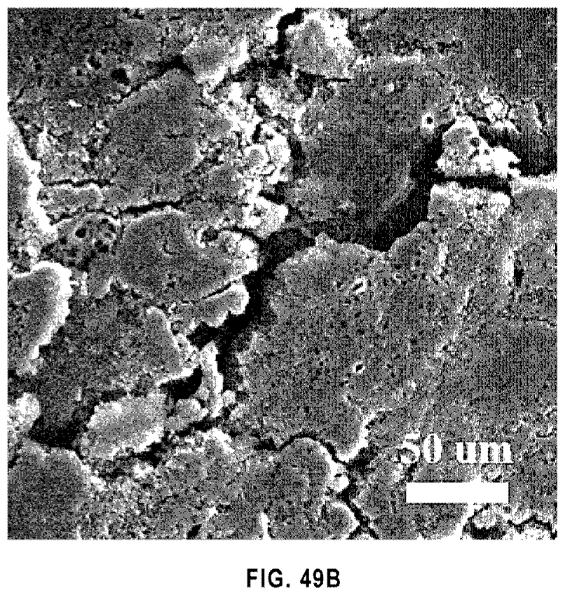

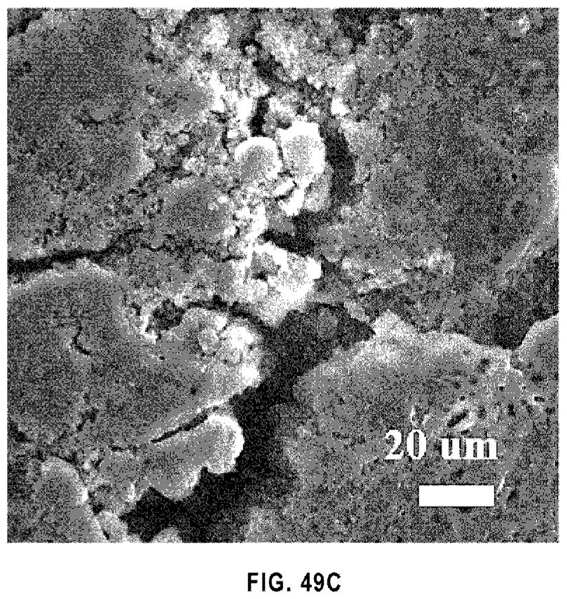

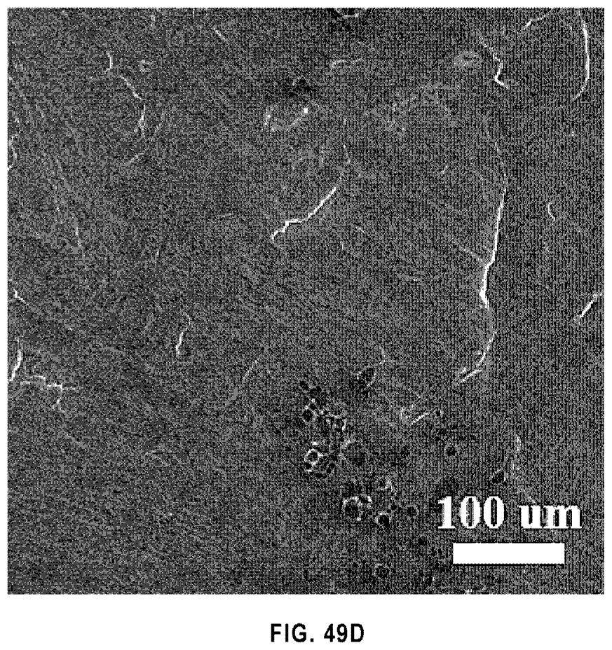

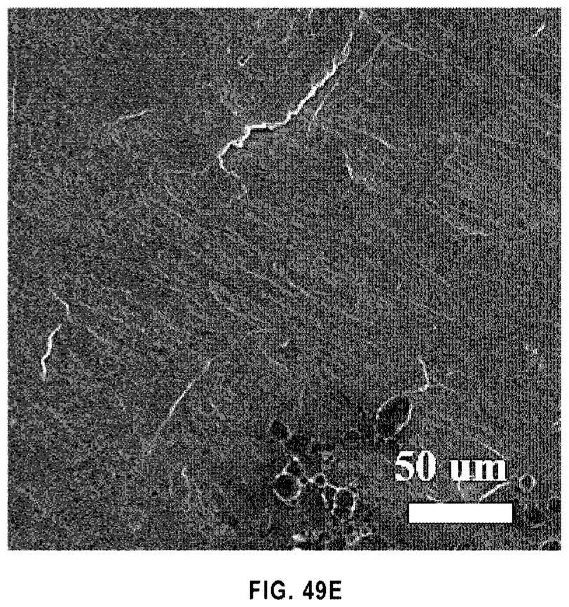

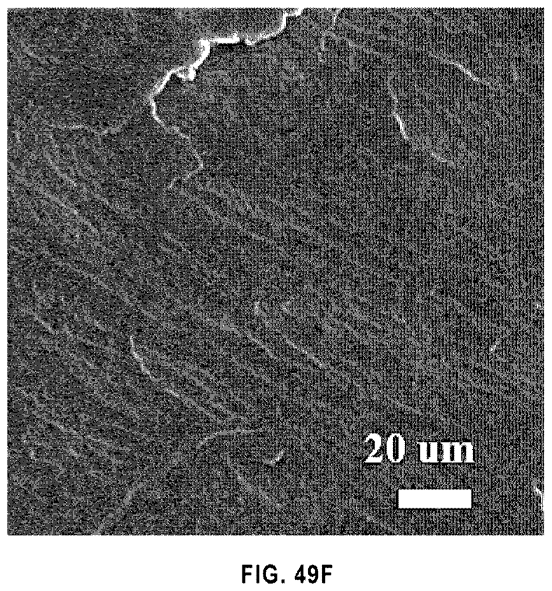

Finally, SEM was used to study the stability of MSAM_{HL/DT} film on Li anode in the DT-HL dual-additives, after 300 cycles. Due to the unstable SEI film, a large number of cracks and mossy Li dendrites are observed on Li anode in DT additive electrolyte (FIG. 49a-c). However, when DT-HL dual-additives were added into ester electrolyte, a dense and stable MSAM_{HL/DT} film and Li dendrite-free formation were observed (FIG. 49d-f), which illustrated the extreme cyclic stability of LiNi_{0.8}Co_{0.1}Mn_{0.1}O₂|Li full cell with DT-HL dual-additives.

### Conclusion

Ester electrolyte containing DT-HL dual-additives led to a dendrite-free Li anode, which could promote its commercial application in Li metal-based batteries.

A self-assembled strategy was developed to form a dense and stable MSAM_{HL/DT} film, which significantly inhibited Li dendrite growth. In addition, the formed MSAM_{HL/DT} film with HL as the core and DT as the shell not only improved the chemical and electrochemical stability of the electrolyte during the Li deposition process, but also reduced the electric field effect on the Li deposition and induced uniformity of Li nucleation.

Therefore, Li|Li symmetric cells with DT-HL dual-additives delivered outstanding cyclic stability for 600 cycles and 150 cycles at current densities of 1 mA cm⁻² and 6 mA cm⁻², respectively. When the ester electrolyte was modified by DT-HL dual-additives, the Li|LiFePO₄ full cell delivered a high specific capacity of 98.64 mAh g⁻¹ under the lean electrolyte (3 μL mg⁻¹).

Finally, high voltage LiNi_{0.8}Co_{0.1}Mn_{0.1}O₂|Li full cells were assembled to further evaluate the stability of ester electrolyte with DT-HL dual-additives.

In summary, an effective in-situ self-assemble strategy with DT-HL dual-additives to form a dense and stable EMSAM_{HL/DT} film on both Li anode and high-voltage cathode surface (e.g. LFP, NCM) have been developed. For Li anode, the formed EMSAM_{HL/DT} film could not only inhibit the electrolyte decomposition, but also induced the uniformity of Li nucleation to prevent Li dendrites growth. Then, the DT-HL dual-additives broadened the ESW of traditional carbonate electrolytes thus enhancing their application field in high-voltage cathode systems. At cathode site, this in-situ strategy is suitable for a series of high-voltage cathode materials (e.g. LFP, NCM) to improve their electrochemical performance due to the formation of stable EMSAM_{HL/DT} film with the ion self-transport channel. For LFP cathode, DT-HL dual-additives can inhibit the generation of Li vacancy defects (Li_{V}) and Fe occupation of Li site (Fe_{Li}) and maintain the structural order of LFP at high mass loading. For NCM cathode, the electrolyte with DT-HL dual-additives can prohibit the formation of Ni²⁺/Li⁺ cation disorder. Finally, the molecular self-assembly proposes a brand-new electrolyte/electrode interface engineering design strategy for the realization of high-voltage and high energy LMBs.

The scope of the claims should not be limited by the preferred embodiments set forth in the examples but should be given the broadest interpretation consistent with the description as a whole.

### REFERENCES

The present description refers to a number of documents, the content of which is herein incorporated by reference in their entirety. These documents include, but are not limited to, the following:
1 Franco, A. A. et al. Boosting Rechargeable Batteries R&D by Multiscale Modeling: Myth or Reality? Chem Rev 119, 4569-4627, doi:10.1021/acs.chemrev.8b00239 (2019).
2 Wu, F., Maier, J. & Yu, Y. Guidelines and trends for next-generation rechargeable lithium and lithium-ion batteries. Chem Soc Rev 49, 1569-1614, doi:10.1039/c7cs00863e (2020).
3 Cheng, X. B., Zhang, R., Zhao, C. Z. & Zhang, Q. Toward Safe Lithium Metal Anode in Rechargeable Batteries: A Review. Chem Rev 117, 10403-10473, doi:10.1021/acs.chemrev.7b00115 (2017).
4 Sun, X. et al. Revisiting the Electroplating Process for Lithium-Metal Anodes for Lithium-Metal Batteries. Angewandte Chemie 59, 6665-6674, doi:10.1002/anie.201912217 (2020).
5 Wang, J. et al. In Situ Self-Assembly of Ordered Organic/Inorganic Dual-Layered Interphase for Achieving Long-Life Dendrite-Free Li Metal Anodes in LiFSI-Based Electrolyte. Advanced Functional Materials 31, doi:10.1002/adfm.202007434 (2020).
6 Deng, W. et al. Competitive Solvation-Induced Concurrent Protection on the Anode and Cathode toward a 400 Wh kg−1 Lithium Metal Battery. ACS Energy Letters 6, 115-123, doi:10.1021/acsenergylett.0c02351 (2020).
7 Xie, Z. et al. 2-Fluoropyridine: A novel electrolyte additive for lithium metal batteries with high areal capacity as well as high cycling stability. Chemical Engineering Journal 393, doi:10.1016/j.cej.2020.124789 (2020).
8 Ma, Q. et al. Formulating the Electrolyte Towards High-Energy and Safe Rechargeable Lithium-Metal Batteries. Angew Chem Int Ed Engl, doi:10.1002/anie.202103850 (2021).
9 Wu, L.-N. et al. Suppressing lithium dendrite growth by a synergetic effect of uniform nucleation and inhibition. Journal of Materials Chemistry A 8, 4300-4307, doi:10.1039/c9ta13644d (2020).
10 Kong, X., Rudnicki, P. E., Choudhury, S., Bao, Z. & Qin, J. Dendrite Suppression by a Polymer Coating: A Coarse-Grained Molecular Study. Advanced Functional Materials 30, 1910138, doi:10.1002/adfm.201910138 (2020).
11 Yan, Y. et al. Boosting polysulfide redox conversion of Li—S batteries by one-step-synthesized Co—Mo bimetallic nitride. Journal of Energy Chemistry 61, 336-346, doi:10.1016/j.jechem.2021.03.041 (2021).
12 Xu, P. et al. Efficient Direct Recycling of Lithium-Ion Battery Cathodes by Targeted Healing. Joule 4, 2609-2626, doi:10.1016/j.joule.2020.10.008 (2020).
13 Jung, C.-H., Shim, H., Eum, D. & Hong, S.-H. Challenges and recent progress in LiNixCoyMn1−x−yO2 (NCM) cathodes for lithium ion batteries. Journal of the Korean Ceramic Society 58, 1-27, doi:10.1007/s43207-020-00098-x (2020).
14 Yang, G. et al. Advances in Materials Design for All-Solid-state Batteries: From Bulk to Thin Films. Applied Sciences 10, doi:10.3390/app10144727 (2020).
15 Zhang, J. et al. Emerging applications of atomic layer deposition for lithium-sulfur and sodium-sulfur batteries. Energy Storage Materials 26, 513-533, doi:10.1016/j.ensm.2019.11.025 (2020).
16 Xu, G.-L. et al. Building ultraconformal protective layers on both secondary and primary particles of layered lithium transition metal oxide cathodes. Nature Energy 4, 484-494, doi:10.1038/s41560-019-0387-1 (2019).
17 Cheng, X. B. et al. A Review of Solid Electrolyte Interphases on Lithium Metal Anode. Adv Sci (Weinh) 3, 1500213, doi:10.1002/advs.201500213 (2016).
18 Kang, T. et al. Self-Assembled Monolayer Enables Slurry-Coating of Li Anode. ACS Cent Sci 5, 468-476, doi:10.1021/acscentsci.8b00845 (2019).
19 Li, C., Li, L. & Wang, C. Study of the inhibitive effect of mixed self-assembled monolayers on copper with SECM. Electrochimica Acta 115, 531-536, doi:10.1016/j.electacta.2013.11.029 (2014).
20 Yu, H., Li, C., Yuan, B., Li, L. & Wang, C. The inhibitive effects of AC-treated mixed self-assembled monolayers on copper corrosion. Corrosion Science 120, 231-238, doi:10.1016/j.corsci.2017.03.006 (2017).
21 Yihong, W., Song, W., Jie, Z., Ning, G. & Wesche, K. D. Preparation and study of complex self-assembled film as a super-thin barrier on silver. Applied Surface Science 252, 8264-8269, doi:10.1016/j.apsusc.2005.10.053 (2006).
22 Shellaiah, M., Wu, Y. H. & Lin, H. C. Simple pyridyl-salicylimine-based fluorescence “turn-on” sensors for distinct detections of Zn2+, Al3+ and OH− ions in mixed aqueous media. The Analyst 138, 2931-2942, doi:10.1039/c3an36840h (2013).
23 Chen, H. et al. Uniform High lonic Conducting Lithium Sulfide Protection Layer for Stable Lithium Metal Anode. Advanced Energy Materials 9, doi:10.1002/aenm.201900858 (2019).
24 Guo, J., Wen, Z., Wu, M., Jin, J. & Liu, Y. Vinylene carbonate-LiNO3: A hybrid additive in carbonic ester electrolytes for SEI modification on Li metal anode. Electrochemistry Communications 51, 59-63, doi:10.1016/j.elecom.2014.12.008 (2015).
25 Membreño, N., Park, K., Goodenough, J. B. & Stevenson, K. J. Electrode/Electrolyte Interface of Composite α-Li3V2(PO4)3 Cathodes in a Nonaqueous Electrolyte for Lithium Ion Batteries and the Role of the Carbon Additive. Chemistry of Materials 27, 3332-3340, doi:10.1021/acs.chemmater.5b00447 (2015).
26 Dai, H., Xi, K., Liu, X., Lai, C. & Zhang, S. Cationic Surfactant-Based Electrolyte Additives for Uniform Lithium Deposition via Lithiophobic Repulsion Mechanisms. J Am Chem Soc 140, 17515-17521, doi:10.1021/jacs.8b08963 (2018).
27 Zhang, R. et al. Lithiophilic Sites in Doped Graphene Guide Uniform Lithium Nucleation for Dendrite-Free Lithium Metal Anodes. Angewandte Chemie 56, 7764-7768, doi:10.1002/anie.201702099 (2017).
28 Wang, H. et al. Electrolytes Enriched by Crown Ethers for Lithium Metal Batteries. Advanced Functional Materials, 2002578, doi:10.1002/adfm.202002578 (2020).
29 Valette, G. Inner-layer capacity at the PZC for perfect (111), (100) and (100) faces of silver: Surface area and capacitance contributions of superficial defects for real electrodes. J. Electroanal. Chem. 224, 285-294, doi:10.1016/0022-0728 (87) 85100-8 (1987).
30 Yan, C. et al. Regulating the Inner Helmholtz Plane for Stable Solid Electrolyte Interphase on Lithium Metal Anodes. Journal of the American Chemical Society 141, 9422-9429, doi:10.1021/jacs.9b05029 (2019).
31 Porter, M. D. et.al. Spontaneously organized molecular assemblies. 4. Structural characterization of n-alkyl thiol monolayers on gold by optical ellipsometry, infrared spectroscopy, and electrochemistry. Journal of the American Chemical Society 109, 3559-3568, doi:10.1021/ja00246a011 (1987).
32 Kim, J. Y. et al. Effect of the dielectric constant of a liquid electrolyte on lithium metal anodes. Electrochimica Acta 300, 299-305, doi:10.1016/j.electacta.2019.01.113 (2019).
33 Qin, X., Shao, M. & Balbuena, P. B. Elucidating mechanisms of Li plating on Li anodes of lithium-based batteries. Electrochimica Acta 284, 485-494, doi:10.1016/j.electacta.2018.07.159 (2018).
34 Inzelt, G. Milestones of the development of kinetics of electrode reactions. Journal of Solid State Electrochemistry 15, 1373-1389, doi:10.1007/s10008-011-1301-3 (2011).
35 Dong, J., Dai, H., Fan, Q., Lai, C. & Zhang, S. Grain refining mechanisms: Initial levelling stage during nucleation for high-stability lithium anodes. Nano Energy 66, 104128, doi:10.1016/j.nanoen.2019.104128 (2019).
36 Li, J. et al. Preparation and Properties of SBS-g-GOs-Modified Asphalt Based on a Thiol-ene Click Reaction in a Bituminous Environment. Polymers 10, doi:10.3390/polym10111264 (2018).
37 Zhang, J., Xu, H., Guo, J., Chen, T. & Liu, H. Superhydrophobic Polypyrrole-Coated Cigarette Filters for Effective Oil/Water Separation. Applied Sciences 10, 1985, doi:10.3390/app10061985 (2020).
38 Wood, K. N. & Teeter, G. XPS on Li-Battery-Related Compounds: Analysis of Inorganic SEI Phases and a Methodology for Charge Correction. ACS Applied Energy Materials 1, 4493-4504, doi:10.1021/acsaem.8b00406 (2018).
39 Contour, J. et al. Analysis by electron-microscopy and XPS of lithium surfaces polarized in anhydrous organic electrolytes. Journal de Microscopie et de Spectroscopie Electroniques 4, 483-491 (1979).
40 Meng, J., Chu, F., Hu, J. & Li, C. Liquid Polydimethylsiloxane Grafting to Enable Dendrite-Free Li Plating for Highly Reversible Li-Metal Batteries. Advanced Functional Materials 29, 1902220, doi:10.1002/adfm.201902220 (2019).
41 Chen, K.-H. et al. Dead lithium: mass transport effects on voltage, capacity, and failure of lithium metal anodes. Journal of Materials Chemistry A 5, 11671-11681, doi:10.1039/c7ta00371d (2017).
42. J. Korean Ceram. Soc.2019, 56, 233-255.
43. Electrochim. Acta 2016, 211, 822-831.
44. ACS Energy Lett. 2021, 6, 1377-1382.
45. J. Power Sources. 2020, 445, 227337.
46. J. Power Sources 2019, 423, 246-254.
47. Sustain. Energy Fuels 2018, 2, 413-421.
48. Adv. Energy Mater. 2019, 9, 1803963.
49. J. Mater. Chem. A 2013, 1, 11848-11852.
50. Energy Storage Mater. 2021, 34, 241-249.
51. Adv. Funct. Mater. 2020, 30, 1910138.
52. Energy Storage Mater. 2019, 16, 85-90.
53. ACS Energy Lett. 2019, 5, 180-186.
54. Nat. Commun. 2019, 10, 1896.
55. Adv. Mater. 2017, 29, 1702714.
56. Nat. Commun. 2014, 5, 5193.
57. Adv. Funct. Mater. 2021, 31, 2100537.
58. Nano Energy 2019, 62, 11-19.
59. Analyst, 2013, 138, 2931
60. EP3132489A1
61. US20120009485A1
62. U.S. Pat. No. 8,334,404B2
63. U.S. Pat. No. 7,172,834B1
64. U.S. Pat. No. 10,193,354B2
65. US20170025706A1
66. U.S. Pat. No. 9,466,857B1
67. US2020112058A1
68. CN105336991A

1. An additive combination for an electrolyte for a secondary battery, the additive combination comprising a thiol compound and an aromatic Schiff base.

2. (canceled)

3. An electrode having a surface and comprising a layer on said surface, wherein said layer comprises a thiol compound and a aromatic Schiff base.

4. A method of manufacturing an electrode, the method comprising the steps of allowing a thiol compound and an aromatic Schiff base to self-assembled on a surface of said electrode to form a layer.

5. The electrode of claim 3, wherein the thiol compound and the aromatic Schiff base in a thiol compound/aromatic Schiff base gravimetric ratio between about 6 and about 2000.

6. The electrode of claim 3, wherein the thiol compound is of formula (1): 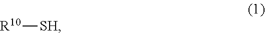
wherein R¹⁰ is a linear or branched alkyl, unsubstituted or substituted by one or more of —COOH, —SH, —C(═O)—R²⁰, —NH₂, or —O—C(═O)—R²⁰, and
wherein R²⁰ is a linear or branched alkyl, a cycloalkyl, or a heterocycloalkyl, each of which being unsubstituted or substituted by one or more of —COOH, —SH, or —C—O—R²¹, wherein R²¹ is a linear or branched alkyl.

7. The electrode of claim 6, wherein R¹⁰ is a linear or branched C₁-C₁₈ alkyl.

8. (canceled)

9. (canceled)

10. (canceled)

11. (canceled)

12. (canceled)

13. (canceled)

14. The electrode of claim 6, wherein the thiol compound is methanethiol, ethanethiol, ethanedithiol, 1-propanethiol, 1,3-propanedithiol, captopril, tert-dodecyl mercaptan, 1-dodecanethiol, hexadecanethiol, 16-Mercaptohexadecanoic acid, or occtadecanethiol.

15. (canceled)

16. The electrode of claim 3, wherein the aromatic Schiff base is of formula (2):
R³⁰—N═CH—R⁴⁰, (2)
wherein R³⁰ and R⁴⁰ are independently aryl or heteroaryl, each independently unsubstituted or substituted with one or more of —OH, alkyl, a halogen atom, or a sulfur atom.

17. The electrode of claim 16, wherein the aryl and/or heteroaryl in R³⁰ and R⁴⁰ are independently unsubstituted or substituted with one or more of the following substituents: OH, alkyl, a halogen atom, or a sulfur atom.

18. (canceled)

19. (canceled)

20. (canceled)

21. (canceled)

22. The electrode of claim 16, wherein the aryl in R³⁰ and/or R⁴⁰ is phenyl.

23. The electrode of claim 16, wherein R⁴⁰ is 2-hydroxyphenyl.

24. The electrode of claim 16, wherein the heteroaryl in R³⁰ and/or R⁴⁰ is a one- or two-ring heteroaryl,
wherein the ring(s) of the heteroaryl in R³⁰ and/or R⁴⁰ comprises 5 or 6 ring atoms, and
wherein the ring(s) of the heteroaryl in R³⁰ and/or R⁴⁰ comprises at least one heteroatom.

25. The electrode of claim 16, wherein the heteroaryl in R³⁰ and/or R⁴⁰ is pyridinyl.

26. (canceled)

27. The electrode of claim 16, wherein the aromatic Schiff base is one of the following:
2-((Pyridin-2-ylimino)methyl)phenol,
2-((3-methylpyridin-2-ylimino)methyl)phenol,
2-((4-methylpyridin-2-ylimino)methyl)phenol,
2-((4-alkylpyridin-2-ylimino)methyl)phenol,
2-((3-alkylpyridin-2-ylimino)methyl)phenol,
2-((4-fluoropyridin-2-ylimino)methyl)phenol,
2-((4-thiopyridin-2-ylimino)methyl)phenol,
2-((3-fluoropyridin-2-ylimino)methyl)phenol, or
2-((3-thiopyridin-2-ylimino)methyl)phenol.

28. An electrolyte for a secondary battery, the electrolyte comprising a conducting salt and the additive combination of claim 1.

29. A method of manufacturing an electrolyte for a secondary battery, the method comprising the step of combining together a conducting salt and the additive combination of claim 1.

30. The electrolyte of claim 28, wherein the electrolyte comprises between about 0.1 and about 15 v/v % of the thiol compound based on the total volume of the electrolyte.

31. The electrolyte of claim 28, wherein the electrolyte comprises between about 0.1 mol L⁻¹ and about 10.0 mol L⁻¹ of the of Schiff base.

32. (canceled)

33. A secondary battery comprising an anode, a cathode, and the electrolyte of claim 28 between the anode and the cathode, wherein at least one electrode surface bears a layer comprising the thiol compound and the aromatic Schiff base.

34. (canceled)

35. A method of manufacturing a secondary battery in which at least one electrode surface bears a layer comprising a thiol compound and a aromatic Schiff base, the method comprising the steps of assembling together an anode, a cathode, and the electrolyte of claim 28 between the anode and the cathode.

36. (canceled)
